(19) United States
(12) Patent Application Publication
(10) Pub. No.: US 2015/0047598 A1
(43) Pub. Date: Feb. 19, 2015

(54) CRANKCASE COVER FOR A FOUR-STROKE ENGINE

(71) Applicants: Jeffrey J. Osterchill, Davidson, NC (US); Justin K. Murnan, New Boston, TX (US); Justin Wilkey, Nash, TX (US)

(72) Inventors: Jeffrey J. Osterchill, Davidson, NC (US); Justin K. Murnan, New Boston, TX (US); Justin Wilkey, Nash, TX (US)

(73) Assignee: HUSQVARNA CONSUMER OUTDOOR PRODUCTS N.A. INC., Charlotte, NC (US)

(21) Appl. No.: 14/118,882

(22) PCT Filed: Jan. 31, 2012
(86) PCT No.: PCT/US2012/023401

§ 371 Date: Oct. 30, 2014

Related U.S. Application Data
(60) Provisional application No. 61/488,088, filed on May 19, 2011.

(51) Int. Cl. F01M 11/12; F02B 75/02

(52) U.S. Cl. CPC F01M 11/12; F02B 75/02; F02B 2075/027
USPC 123/196 R

(57) ABSTRACT

Crankcase cover for sealing an opening in a crankcase the crankcase cover includes a body portion configured to be removeably coupled to the crankcase and a fluid level window. The fluid level window can have a flat portion with fluid level indicators thereon to signify the level of lubricant within the crankcase. The fluid level window is in fluid communication with fluid in the crankcase so that the fluid level within the crankcase can be seen through the fluid level window.

### FIELD

This disclosure relates to four-stroke engines, and more particularly, to a crankcase cover for a four-stroke engine.

### BACKGROUND

Four-stroke internal combustion engines can be used in outdoor power tools, such as line-trimmers, edgers, chain saws, blowers, and the like. Typical four-stroke internal combustion engines include a crankcase, a cylinder communicating with the crank case, and a piston configured for reciprocation within the cylinder. Additionally, lubricant is often introduced into the crankcase to lubricate the moving parts of the engine. Typically a minimum amount of lubricant is required to ensure that the moving parts of the engine do not wear or damage quickly.

### SUMMARY

A crankcase cover for a four-stroke engine is presented to provide an indication of the level of lubricant in the four-stroke engine. One embodiment takes the form of a four-stroke engine having crankcase. The crankcase includes an opening. A crankcase cover is coupled to the crankcase to cover the opening. The crankcase cover can seal the opening formed in the crankcase. The crankcase cover includes a fluid level window and body portion. In one embodiment, the fluid level window extends beyond the body portion. The fluid level window can include fluid level indicators formed thereon to indicate the level of the oil within the crankcase. In another embodiment, the fluid level window and the body portion can be co-molded to one another.

### BRIEF DESCRIPTION OF THE DRAWINGS

The foregoing features of the disclosure will be more readily understood by reference to the following detailed description, taken with reference to the accompanying drawings, in which:

FIG. 1 is a cross-section of a four-stroke engine having an exemplary mechanical breather assembly in accordance with an exemplary embodiment;

FIG. 2 is a cross-section of a four-stroke engine having a crankcase cover in accordance with an exemplary embodiment;

FIG. 3 is an exploded perspective view of an exemplary mechanical breather assembly and a crankcase cover in accordance with an exemplary embodiment;

FIG. 4 is a perspective view of an exemplary breather bearing;

FIG. 5 is a front elevational view of the breather bearing illustrated in FIG. 4 in accordance with an exemplary embodiment;

FIG. 6 is an exploded perspective view of a four-stroke engine having an exemplary mechanical breather assembly in accordance with an exemplary embodiment excluding the crankshaft;

FIG. 7 is an exemplary mechanical breather system shown in an exploded view with a crankshaft of a full-crank engine;

FIG. 8 is a side elevational view of the mechanical breather system illustrated in FIG. 7;

FIG. 9 is a cross-section of a four-stroke engine having an exemplary mechanical breather system in a full-crank engine;

FIG. 10 is a perspective view of a four-stroke engine having an exemplary mechanical breather system in an assembled configuration;

FIG. 11 is a partial view of the four-stroke engine illustrated in FIG. 10;

FIG. 12 is a cross-section of a four-stroke engine having another exemplary mechanical breather assembly;

FIG. 13 is an assembly view of the exemplary mechanical breather assembly illustrated in FIG. 12;

FIG. 14 is a perspective view of an assembled mechanical breather assembly illustrated in FIG. 12;

FIG. 15 is a perspective view of the rotating member, rotating member shaft and bearing illustrated in FIG. 12;

FIG. 16 is a plan view of the rotating member, rotating member shaft and bearing illustrated in FIG. 15;

FIG. 17 is an exemplary four-stroke engine having crankcase cover in accordance with an exemplary embodiment;

FIG. 18 is a detailed view of the exemplary four-stroke engine having the exemplary crankcase cover as illustrated in FIG. 17; and

FIG. 19 is an interior view of the exemplary crankcase cover illustrated in FIG. 18;

FIG. 20 is a front view of the exemplary four-stroke engine and crankcase cover illustrated in FIG. 18;

FIG. 21 is a side profile view of an exemplary four-stroke engine assembled with a crankcase cover in accordance with an exemplary embodiment;

FIG. 22 is an assembly view of FIG. 2;

FIG. 23 is side profile view of another example of a crankcase cover in accordance with an exemplary embodiment of the present disclosure;

FIG. 24 is a cross-sectional view of another example of a crankcase cover in accordance with an exemplary embodiment of the present disclosure;

FIG. 25 is perspective view of another example of a crankcase cover in accordance with an exemplary embodiment of the present disclosure;

FIG. 26 is a side profile view of an exemplarily four-stroke engine assembled with another example of a crankcase cover in accordance with an exemplary embodiment;

FIG. 27 is an assembly view of another example of a crankcase cover in accordance with an exemplary embodiment of the present disclosure;

FIG. 28A is an example of a full crank engine, according to the present disclosure, having a fluid level window located on the crankcase;

FIG. 28B is another example of a full crank engine, according to the present disclosure, having a fluid level window located on the crankcase cover; and

FIG. 28C is another example of a full crank engine, according to the present disclosure, having a fluid level window located on the crankcase cover in another position as compared to FIG. 28B;

### DETAILED DESCRIPTION

A four-stroke engine including a crankcase cover configured according to the present teachings will hereinafter be described more fully with reference to the accompanying drawings in which embodiments of the crankcase cover are illustrated. The crankcase cover can, however, be embodied in many different forms and should not be construed as limited to the embodiments set forth herein. Rather, these embodiments are provided so that this disclosure will be thorough and complete, and will fully convey the scope of the disclosure to those persons skilled in the art. In the figures and description, like reference numbers refer to like elements throughout.

Lubricant is typically introduced into engines to lubricate the moving parts of the engine. A minimum amount or level of lubricant is often required to reduce wear and damage of the moving parts. As described herein, a crankcase cover is disclosed that allows for monitoring and determining the level of lubricant in an engine. While the embodiments described herein focus on the implementation of a crankcase cover for an outdoor power tool, other tools and machines having a four-stroke engine are also considered within the scope of this disclosure. For example, such tools and machines can include pressure cleaners, generators, powered scooters, all-terrain vehicles, side-by-side vehicles and motorcycles.

A four-stroke engine creates power though combustion in one or more cylinders. The four-strokes are typically referred to as an intake stroke, compression stroke, combustion stroke and exhaust stroke. During the intake stroke, the piston moves downward from a top dead center position as a mixture of air and fuel is forced into the cylinder. In the compression stroke, the air and fuel mixture is compressed in the cylinder. A spark can be used for ignition if the four-stroke engine is a gasoline powered engine or other similar fuel mixture powered engine. In other instances, the compression coupled with some heat can cause ignition. As the fuel burns, it produces a gas forcing the piston downward again. Then, during the exhaust stroke, the combusted gases are exhausted through an exhaust valve. During the compression stroke, the rings sealing the piston can allow the gasses to enter the crankcase. Additionally, the motion of the piston within cylinder can cause the crankcase to increase in internal pressure as the crankcase is fluidly coupled to bottom of the cylinder. Lubricant is typically introduced into the crankcase of the engine to lubricate the moving parts of the engine, for example the crankshaft and the reciprocating pistons.

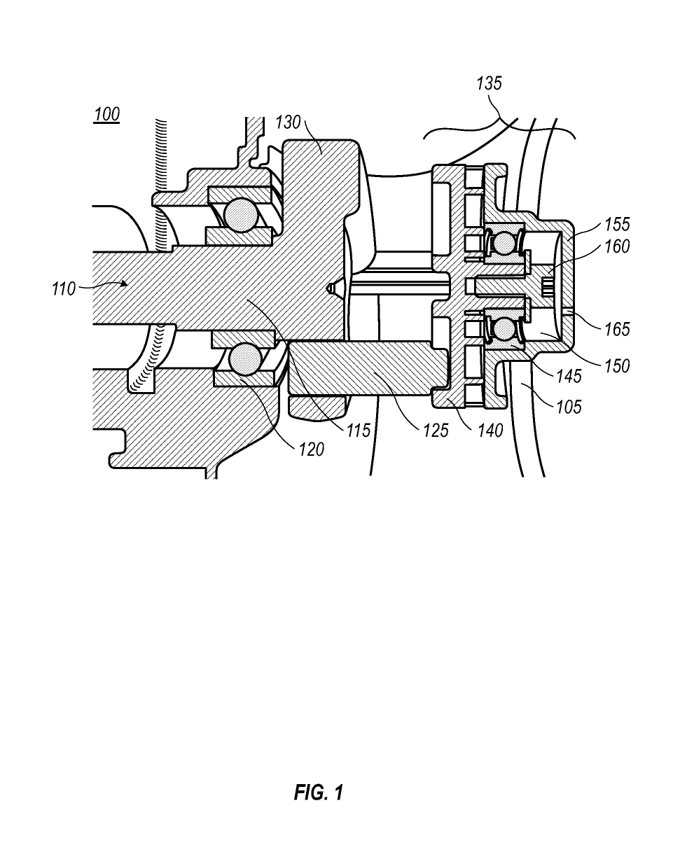

In order to more fully illustrate the present disclosure, some elements of the engine and crankcase are omitted in the drawings to more fully disclose the relevant portions thereof. For example, the piston and cylinder have not been illustrated. FIG. 1 illustrates a cross-section of a four-stroke engine 100 including a crankcase 105. Additionally, a crankshaft 110 is illustrated. The crankshaft 110 rotates within the crankcase 105 as the piston (not shown) reciprocates within the cylinder. The piston can be coupled to the crankshaft 110 via a connecting rod which is in turn coupled to the crankshaft 110. In a half-crank engine, the crankshaft 110 can be supported at one position by at least one bearing 120. The crankshaft 110 is also supported within the crankcase 105 on only one end. In other embodiments, the engine can be a full-crank engine, and the crankshaft 110 can be supported on at least both ends as will be described below. Additionally, the rotating member 140 is driven directly by the crankshaft 110 in that an extended crank pin serves as a connecting member 125 and drives the rotating member 140. The at least one bearing can be sealed or unsealed. The bearing allows the crankshaft 110 to easily rotate.

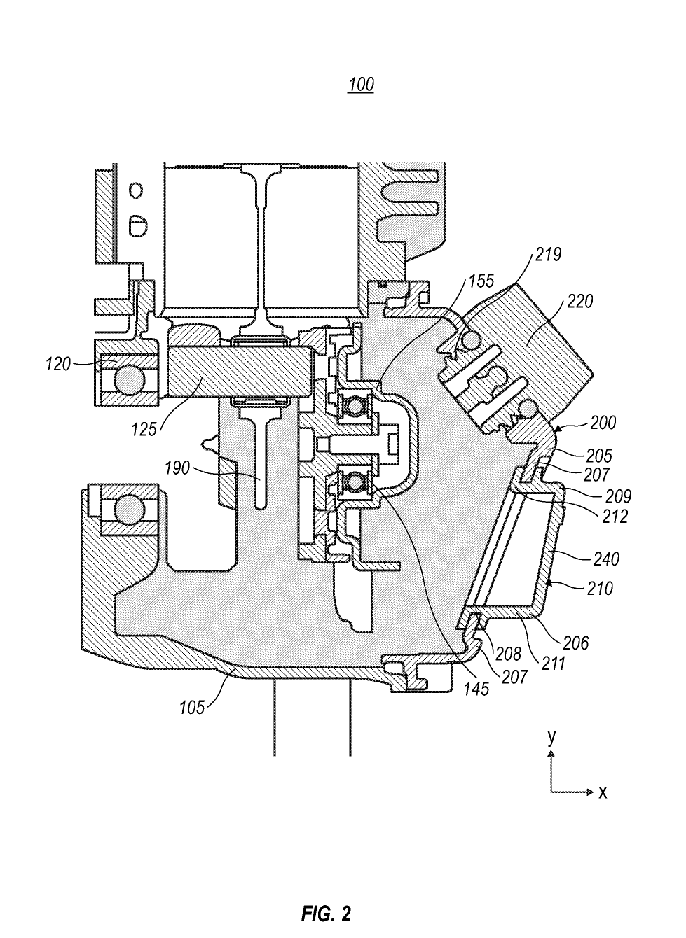

The engine illustrated in FIGS. 1 and 2 also includes a mechanical breather system 135 that comprises a rotating member 140 coupled to the crankshaft 110, a breather bearing 145 positioned adjacent to the rotating member 140, an air receiving chamber 150 positioned on the breather bearing 145 and opposite from the rotating member 140, and a passage 165 in fluid communication with an interior of the air receiving chamber 150 and an exterior of the air receiving chamber 150. As illustrated in FIG. 1, the crankshaft 110 is received in the crankcase 105 and supported by at least one bearing 120. The crankshaft 110 also includes a counterweight 130 on a first end 115 of the crankshaft 115.

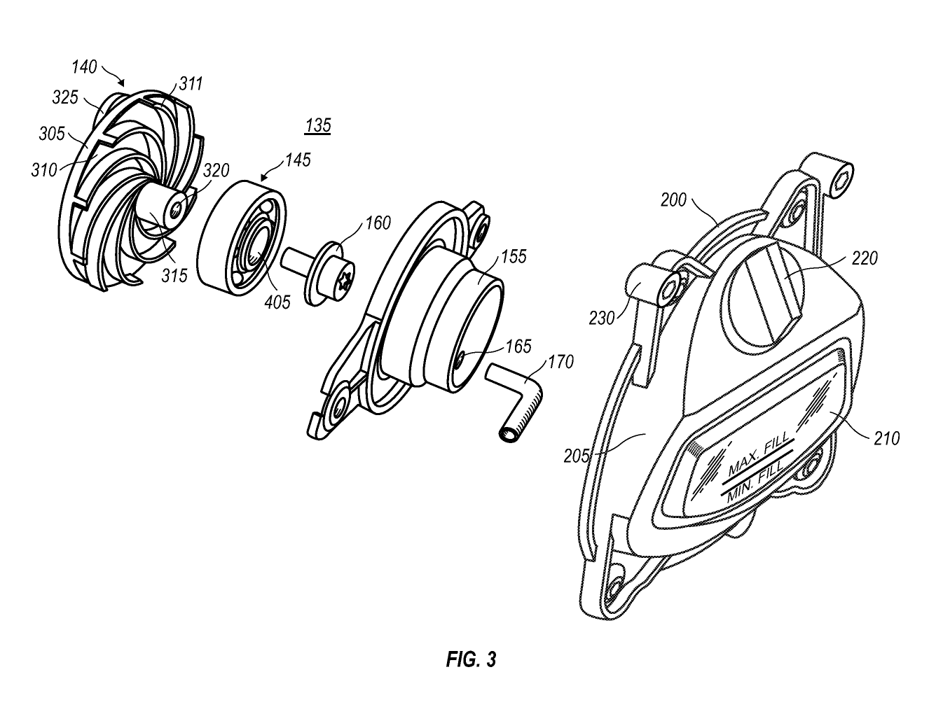

A connecting member 125 couples the crankshaft 110 to a rotating member 140. The connecting member 125 couples the mechanical breather system 135 to the crankshaft 110. For example, the rotating member 140 can be driven directly or indirectly by the crankshaft 110. When the rotating member 140 is directly driven, the rotating member 140 can be affixed to the crankshaft 110 or driven by a connecting member 125 such as a crankpin. When the rotating member 140 is indirectly driven, another mechanism couples the rotating member 140 to the crankshaft 110 so that different speeds or direction of motion may be achieved by the rotating member 140 as compared with the crankshaft 110. As illustrated, the connecting member 125 is coupled at a first end to the counterweight 130 of the crankshaft 110. In FIG. 1, the rotating member 140 is configured to receive the second end of the connecting member 125 such that when the crankshaft 110 rotates, the connecting member 125 causes the rotating member 140 to rotate. While the connecting member 125 directly connects the crankshaft to the rotating member 140, other connecting members could be implemented whereby the angular acceleration and/or speed of the rotating member 140 can vary from the speed of the crankshaft 110. The rotating member 140 can include at least one inlet channel 310 (described in detail below in regards to FIG. 3). An inlet channel 310 as used herein refers to a pathway for fluid communication between the outer perimeter 305 of the rotating member 140 and an inner region of the rotating member 140. The inlet channel 310 can be formed by one or more vanes 311 as illustrated; further embodiments will be described below. The at least one inlet channel 310 of the rotating member 140 allows for oil to be spun outward while air passes through a breather bearing 145 positioned adjacent thereto.

The breather bearing 145 is positioned adjacent to the rotating member 140. As illustrated, the crankshaft 110 and counterweight 130 are on the same side of breather bearing 145. The crankshaft 110 and the rotating member 140 are configured such that when the crankshaft 110 rotates the rotating member 140 rotates. In one embodiment, the breather bearing 145 is mounted to an internal portion of the crankcase 105. In another embodiment, illustrated in FIGS. 1 and 2, the breather bearing 145 can also be coupled to a breather housing 155, which in turn is coupled to the crankcase 105. In the illustrated embodiment, the coupling of the breather bearing 145 to the crankcase 105 or breather housing 155 can be a press-fit, welded or other suitable mounting configuration that maintains position during use of the engine 100. The breather bearing 145 is configured to allow air to pass from one side of the breather bearing 145 to the other side of the breather bearing 145. For example, with respect to the exemplary four-stroke engine 100 illustrated in FIGS. 1-2, air will pass from the left side of the breather bearing 145 to the right side of the breather bearing 145. An example of a breather bearing 145 configured according to the present disclosure will be provided in detail hereinbelow.

In the illustrated embodiments of FIGS. 1 and 2, a rotating member support member 160 positions the rotating member 140 relative to the breather housing 155 and the breather bearing 145. An air receiving chamber 150 is positioned on the breather bearing 145 on a side of the breather bearing 145 opposite from the rotating member 140. A passage 165 is provided through a wall of the air receiving chamber 150 such that the passage 165 is in fluid communication with an interior of the air receiving chamber 150 and an exterior of the air receiving chamber 150. As illustrated in FIG. 1, the coupling of the breather housing 155 and the breather bearing 145 defines the air receiving chamber 150. The top wall of the breather housing 155 that faces outwardly with respect to the rotating member 145 and the crankshaft 110 can provide the wall for the passage 165 that is in fluid communication with the interior of the air receiving chamber 150 and the exterior of the air receiving chamber 150. As seen in FIG. 1, the interior of the air receiving chamber 150 is the area between the breather bearing 145 and the inner face of the top of the breather housing 155. The exterior of the air receiving chamber 150 can be the area on the outer face of the top of the breather housing 155 that is opposite to the inner face of the breather housing 155. While the air receiving chamber 150 as described above is within the breather housing 155, other embodiments of the present disclosure contemplate the inclusion of the air receiving chamber 150 within a portion of the crankcase 105 with or without the presence of a breather housing 155.

Also illustrated in FIG. 2, the engine 100 can include an oil slinging arm 190. The oil slinging arm 190 can be configured to deliver lubricant residing in the crankcase 105 to the moving parts of the engine 100 (for example, the rod and piston). In the illustrated embodiment, as the crankshaft 125 rotates, the oil slinging arm 190 can rotate about the crankshaft 125 and reciprocate within the crankcase 105. As the oil slinging arm 190 reciprocates within the crankcase 105, the oil slinging arm 190 can become coated with lubricant residing in the crankcase 105. As the oil slinging arm 190 reciprocates and rotates about the crankshaft 125, the lubricant coated on the oil slinging arm 190 is delivered onto the rod and piston of the engine 100. For example, by virtue of the centrifugal force exerted by movement of the oil slinging arm 190, the lubricant can be dispersed throughout the crankcase 105. Lubricant can be introduced into the engine through a plug receiving hole 219 defined in the crankcase cover 200.

In FIG. 2, the engine 100 includes a crankcase cover 200. The crankcase cover 200 is adapted to seal an opening 215 (see FIGS. 6, 10, and 11) formed in the crankcase 105. The crankcase cover 200 can be removeably coupled to the crankcase 105. In at least one embodiment, the crankcase cover 200 can be coupled to the crankcase 105 via fasteners, such as, for example screws, bolts, a snap-fit attachment, or other coupling that permits the crankcase cover 200 to be removeably coupled to the crankcase 105. In other embodiments, the crankcase cover 200 may not be removable from the crankcase 105.

In FIG. 2, the crankcase cover 200 comprises a fluid level window 210. The crankcase cover 200 can include a body portion 205. The body portion 205 can be made of the same material as the fluid level window 210 or of a different material. In at least one example, at least a portion of the crankcase cover 200 is substantially translucent. In another example, at least a portion of the crankcase cover 200 is substantially transparent. In yet another example, at least a portion of the crankcase cover 200 is substantially opaque. In other examples, the substantial entirety of the crankcase cover 200 can be one of substantially transparent, translucent or opaque. When the crankcase cover 200 is translucent or opaque, the optical properties of the crankcase cover 200 can be selected to prevent degradation of parts and fluids located within the crankcase 105 and crankcase cover 200. As used herein, transparent refers to materials that allow light to pass through without changing optical properties of the light; translucent refers to materials that allow light to pass through and changes one or more optical properties of the light; opaque refers to a material that does not allow light to pass through it.

The crankcase cover 200 can be removeably coupled to the crankcase 105. The crankcase cover 200 can be formed out of plastic, metal or other suitable material. The body portion 205 of the crankcase cover 200 can include a plug receiving hole 219 defined by the crankcase cover 200 and adapted to receive a lubricant cap 220. For example, the lubricant cap 220 can be an oil-fill plug. The plug receiving hole 219 provides an aperture through which lubricant can be poured or introduced into the crankcase 105. In at least one embodiment, the plug receiving hole 219 can be a threaded opening configured to correspond to threads of a lubricant cap 220. In FIG. 2, the plug receiving hole 219 is disposed above the fluid level window 210. However, those of ordinary skill in the art will appreciate that the plug receiving hole 219 can be located elsewhere on the crankcase cover 200. The lubricant cap 220 is adapted to seal the plug receiving hole 219. While the plug receiving hole 219 has been described as being formed as part of the crankcase cover 200, the plug receiving hole 219 can be located elsewhere on the crankcase 105.

The fluid level window 210 is configured to provide a visual indication of the level of lubricant within the crankcase 105. The fluid level window 210 can be either transparent or translucent. For example, the fluid level window 210 can comprise a transparent or translucent plastic, plexiglass, a glass, Pyrex, or other suitable translucent material. In one embodiment, the crankcase cover 200 can define a hole (not labeled) configured to receive the fluid level window 210. In at least one example, the fluid level window 210 can be substantially flush with the crankcase cover 200 surrounding the fluid level window 210. In another example, the fluid level window 210 can protrude from the crankcase cover 200 surrounding the fluid level window 210. In yet another example, the fluid level window 210 can recessed from the crankcase cover 200 surrounding the fluid level window 210. When the fluid level window 210 protrudes from the crankcase cover 200, the fluid level window 210 can be better illuminated for reading of the fluid level. When the fluid level window 210 is flush or recessed, the fluid level window 210 can be better protected from damage.

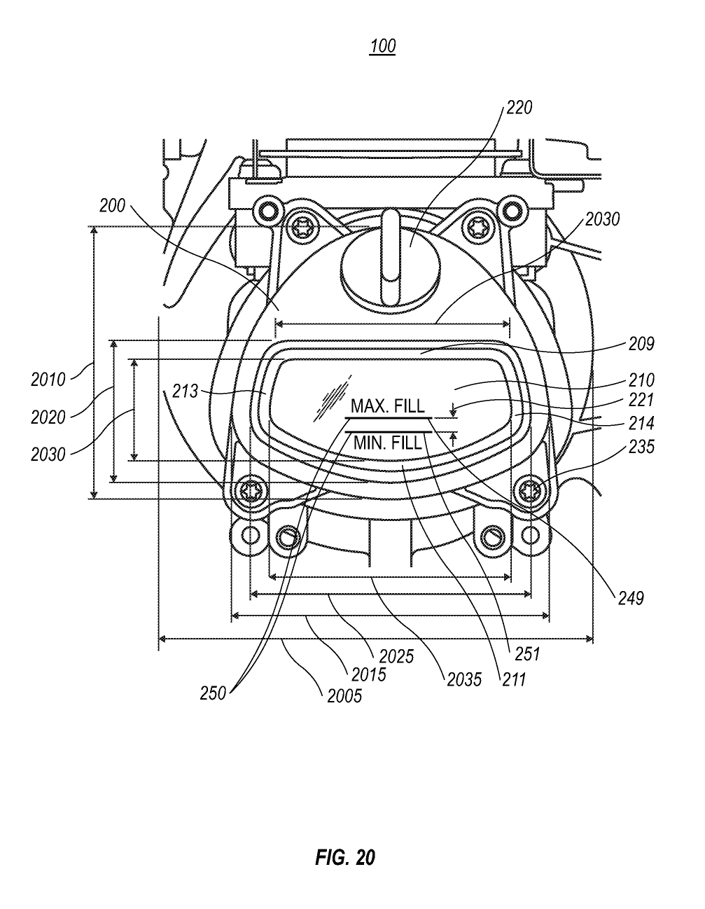

As illustrated in FIG. 2, the fluid level window 210 extends beyond the crankcase cover 200. For example, in FIG. 2, the fluid level window 210 extends a distance beyond the crankcase cover 200 in the x-direction. In other words, the fluid level window 210 can include a proximal end 208 and a distal end 206. In FIG. 2, the proximal end 208 is coupled to the crankcase cover 200, and the distal end 206 extends beyond the crankcase cover 200. The proximal end 208 forms receiving portions for receiving the crankcase cover 200. The proximal end 208 can be formed of the same material as the fluid level window 210. An endcap 240 or flat portion can be located at the distal end 206 of the fluid level window 210. The fluid level window 210 can also include four sides 209, 211, 213, 214. The four sides 209, 211, 213, 214 can extend perpendicular to the endcap 240 towards the proximal end 208 of the fluid level window 210. The four sides 209, 211, 213, 214 can each have a length (labeled in FIG. 20). In at least one embodiment, the four sides 209, 211, 213, 214 can have minimum length 2030 of one (1) centimeter. In another embodiment, the four sides 209, 211, 213, 214 can have a maximum length 2030 of four (4) centimeters. However, in other embodiments, the four sides 209, 211, 213, 214 can have any other length that allows the fluid level window 210 to provide a large enough viewing window to determine the level of lubricant in the crankcase 105. Further details as to the sides 209, 211, 213, 214 and the shape and contour of the fluid level window 210 will be described with respect to FIGS. 18-21. In at least one embodiment, a through hole 216 is formed in the crankcase cover 200. The sides 209, 211, 213, 214 can form a perimeter around the through hole 216. The proximal ends 208, and consequently, the proximal ends of the sides 209, 211, 213, 214, of the fluid level window 210 can be configured to matingly engage with the through hole 216 formed in the body portion 205 of the crankcase cover 200.

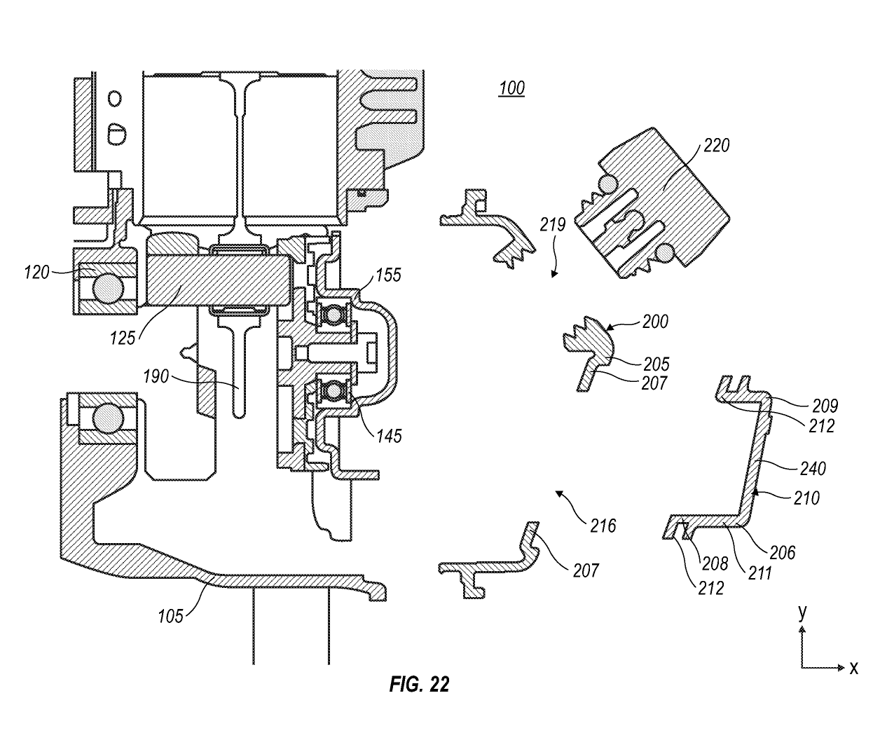

In FIG. 2, the sides 209, 211, 213, 214 of the fluid level window 210 can be shaped to matingly engage with the opening/through hole 216 formed in the body portion 205. For example, the distal end of the sides 209, 211, 213, 214 can include a receiving portion 212 configured to matingly engage the body portion 205. In at least one embodiment, such as in FIG. 2, the body portion 205 can include at least one protrusion 207 configured to matingly engage a receiving portion 212 of the fluid level window 210. The at least one protrusion 207 can be a tab, shaped to matingly correspond to the receiving portion 212 of the fluid level window 210. In the illustrated embodiment, the at least one protrusion 207 circumscribes the opening 216 (illustrated in FIG. 22). In another embodiment, the fluid level window 210 and the body portion 205 are co-molded. For example, the body portion 205 and the fluid level window 210 can be co-molded by a two-shot co-molding process. In a two-shot co-molding process, one of the body portion 205 and the fluid level window 210 is molded in a first shot, and the other of the body portion 205 and the fluid level window 210 is molded in a second shot. In yet other embodiments, the body portion 205 and the fluid level window 210 can be coupled to one another by other coupling mechanisms, for example, by a screw-attachment, by an adhesive attachment, by a gasket type attachment, by a welding attachment, by a nut and bolt attachment, by a vibration welding attachment, or by another coupling mechanism that secures the fluid level window 210 to the body portion 205.

In at least one embodiment, the body portion 205 and the fluid level window 210 can be coupled to one another such that the fluid level window is non-removable from the body portion 205. Additionally, the fluid level window 210 can be coupled to the body portion 205 to form a hermetic seal, thereby ensuring that lubricant within the crankcase 105 does not leak out from the point of coupling between the fluid level window 210 and the body portion 205. While the present disclosure describes the fluid level window 210 as providing an indication of the level of lubricant within the crankcase 105, one of ordinary skill in the art will appreciate that the fluid level window 210 can provide an indication of the level of other fluids or liquids within the crankcase 105; for example, transmission fluid, fuel, or other fluids introduced into the crankcase 105 to permit the engine to operate.

As illustrated in FIG. 2, the crankcase cover 200 seals the crankcase 105 on one end. The breather bearing 145 and breather housing 155 are located within crankcase 105 as sealed by the crankcase cover 200. An air passage can be constructed so as to allow air within the breather housing 155 to exit outside of the crankcase 105.

While the illustrated engine 100 in FIGS. 1 and 2 is a half-crank engine supported by one bearing 120, one of ordinary skill in the art will understand that the engine 100 can be a full-crank engine, as will be described later in this disclosure.

FIG. 3 is an exploded view of the mechanical breather system 135 for a four-stroke engine. The rotating member 140 has at least one inlet channel 310 extending between an outer perimeter 305 of the rotating member 140 and an inner region of the rotating member 140. As illustrated in FIG. 3, the at least one inlet channel 310 is curved between the outer perimeter 305 of the rotating member 140 and the center of the rotating member 140. However, one of ordinary skill in the art will appreciate the at least one inlet channel 310 can extend straight and radially from the center of the rotating member towards the perimeter 305 of the rotating member 140. Additionally, while FIG. 3 illustrates a rotating member 140 having ten inlet channels 310, one of ordinary skill in the art will appreciate that the rotating member 140 can have two inlet channels, three inlet channels, seven inlet channels, thirteen inlet channels, or any number of inlet channels so long as the rotating member has at least one inlet channel 310. While the illustrated embodiment shows the at least one inlet channel 310 formed from a vane 311, one skilled in the art will appreciate that the at least one inlet channel 310 can be an aperture through the rotating member 140 or can be a groove formed in the surface of the rotating member 140. Additionally, as illustrated a plurality of vanes 311 are illustrated and thus a plurality of inlet channels 310. In the illustrated embodiment, ten vanes 311 are illustrated and are shaped with single cup shape along a single radius. In other embodiments, the vanes 311 can have multiple curvatures to encourage the flow of air in the at least one air inlet channel 310.

The rotating member 140 can include a socket 325 configured to receive a second end of the connecting member 125. The socket 325 can be disposed on the face of the rotating member 140 that is opposite to the side having the at least one inlet channel 310. In other embodiments, the connecting member 125 can be coupled to the rotating member 140 through other mounting mechanisms such as a screw, bolt, threaded engagement and the like. In other embodiments, the connecting member 125 can be fixedly attached to the rotating member 140. The rotating member 140 can also include a protrusion 315 that protrudes from substantially the center of the rotating member 140. The protrusion 315 can be provided to receive the breather bearing 145. While the illustrated rotating member 140 in FIG. 3 is an impeller, one of ordinary skill in the art will appreciate that the rotating member 140 can be a rotor having inlet channels, a blower, a turbine, or any other rotating member that can have at least one inlet channel 310 in fluid communication between an outer perimeter 305 of the rotating member 140 and an inner region of the rotating member 140. As illustrated, the at least one inlet channel 310 is formed from the vanes 311 which are integral parts of the rotating member 140. In other embodiments, the vanes 311 can be constructed separately and affixed to the rotating member through welding or the like.

Also illustrated in FIG. 3 is a crankcase cover 200. Similar to the crankcase cover illustrated in FIG. 2, the crankcase cover 200 illustrate in FIG. 3 includes a body portion 205 and a fluid level window 210. Above the fluid level window 210 and formed in the body portion 205 is a plug receiving hole 219 (for example, an aperture). The plug receiving hole 219 is adapted to receive a lubricant cap 220 (for example, an oil fill plug). FIG. 3 illustrates the connection of the crankcase cover 200 to the crankcase 105. In FIG. 3, the crankcase cover 200 can be attached to the crankcase 105 by one or more coupling components, for example screws, bolts, fasteners or other component which can secure the crankcase cover 200 to the crankcase 105. For example, as illustrated in FIG. 3, the crankcase cover 200 includes connecting apertures 230. The connecting apertures 230 can be configured to receive coupling components 235 which can secure the crankcase cover 200 to the engine crankcase 105. For example, in at least one embodiment, the connecting apertures 230 can be ear portions. While FIG. 3 illustrates coupling the crankcase cover 200 to the crankcase 105 by other couplings. For example, the crankcase cover 200 can be coupled to the crankcase 105 by welding, by a snap-engagement, by an adhesive, or by other couplings.

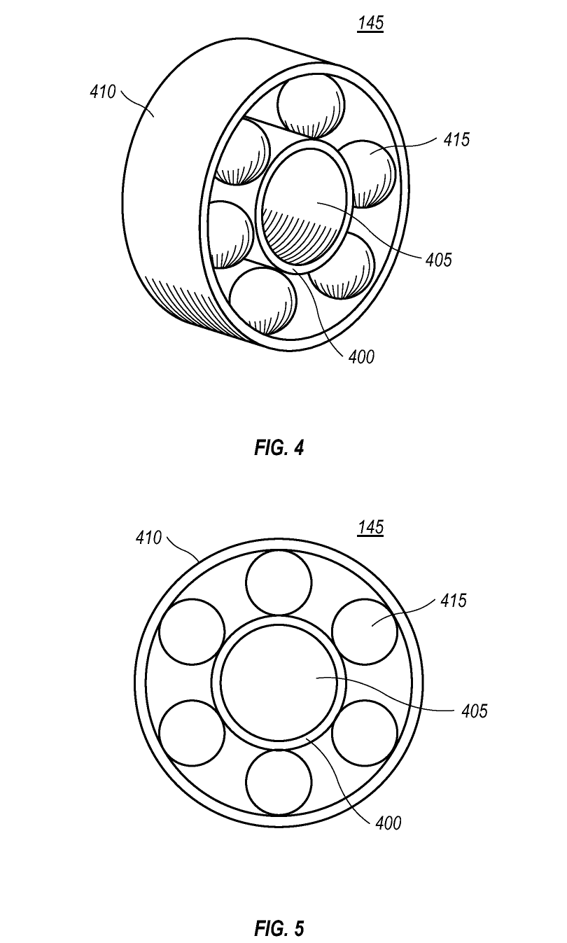

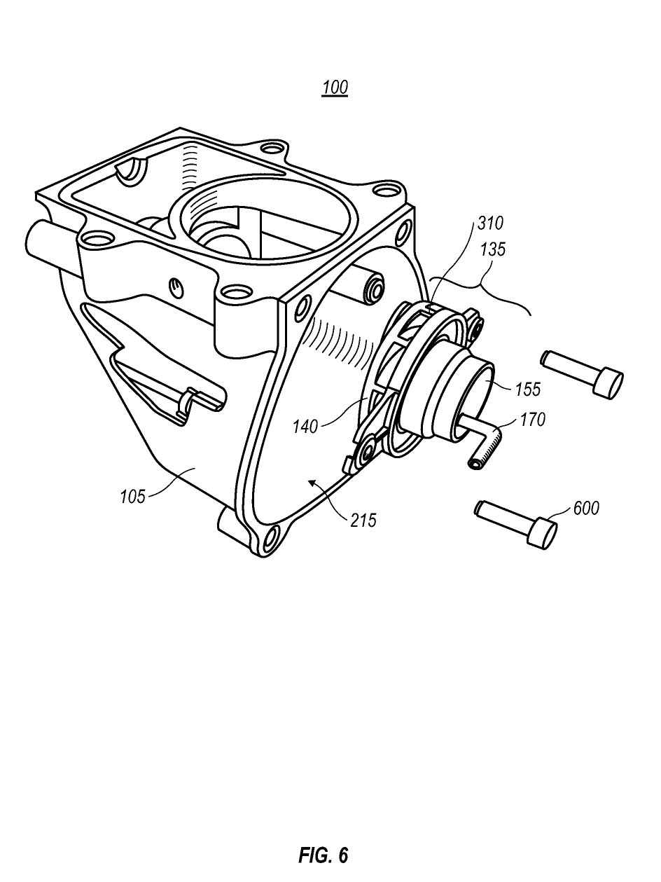

FIGS. 4-5 illustrate a breather bearing 145. The breather bearing 145 has an inner race 400 and an outer race 410. In at least one embodiment, including the illustrated embodiment, the breather bearing 145 can comprise at least one ball bearing. In other embodiments, other types of bearings that allow for air to pass therethrough are considered within the scope of this disclosure. For example, the breather bearing 145 can comprise a needle bearing or a bushing between the inner race 400 and the outer race 410. The breather bearing 145 is be configured to allow air to pass between the inner race 400 and the outer race 410. For example, the inner race 400 and the outer race 410 of the breather bearing 145 can form a space through which air can pass. In at least one embodiment, the breather bearing 145 can be the bearing that supports the crankshaft 110 in the crankcase 105.

FIG. 4 is a perspective view and FIG. 5 is a front view of the breather bearing 145 illustrating the inner race 400, the outer race 410, and the at least one ball bearing 415. The at least one ball bearing 415 is free to move within the inner race 400 and the outer race 410 of the breather bearing 145. While the illustrated embodiments show six ball bearings 415 disposed between the inner race 400 and the outer race 410, one of ordinary skill in the art will appreciate that two ball bearings, three ball bearings, four ball bearings, or more can be disposed within the inner 400 and outer races 410 so long as the breather bearing 145 includes at least one ball bearing 415. In the embodiment illustrated in FIGS. 4-5, the ball bearings 415 can move within the area between the inner 400 and outer races 410 which can facilitate air passage between the ball bearings 415 and between the inner 400 and outer races 410. The breather bearing 145 as illustrated is an unsealed bearing thereby facilitating the passage of air between the inner race 400 and the outer race 410.

In a half-crank engine, the crankshaft 110 does not extend through the crankcase 105. In at least one embodiment, as illustrated in FIG. 3, the breather bearing 145 includes an aperture 405 through the center of the breather bearing 145 that is configured to receive the protrusion 315 of the rotating member 140. The aperture 405 and protrusion 315 are configured to couple the breather bearing 145 with the rotating member 140 such that when the crankshaft 110 rotates the rotating member 140, the breather bearing 145 will also rotate. The cooperation of the aperture 405 and protrusion 315 add further stability to rotating member 140 as it rotates. Furthermore, the protrusion 315 can also include rotating member support aperture 320 which is configured to receive the rotating member support member 160. The rotating member support member 160 can position the rotating member 140 relative to the breather housing 155 and the breather bearing 145. The rotating member support member 160 can also be rotatably coupled to the breather housing 155. The breather housing 155 is configured to receive the breather bearing 145 and to rotatably couple the rotating member 140 to the crankcase 105. The breather housing 155 includes an air receiving chamber aperture 165 through a top wall of the breather housing 155. The air receiving chamber aperture 165 can be configured to receive the exhaust stem 170, as illustrated in FIG. 3. The exhaust stem 170 provides the passage in fluid communication between the interior of the air receiving chamber 150 and the exterior of the air receiving chamber 150. While the embodiment illustrated in FIG. 3 includes an exhaust stem 170 to be inserted into the air receiving chamber aperture 165, one of ordinary skill in the art will appreciate that the air receiving chamber aperture 165 can provide the passage in fluid communication with the interior of the air receiving chamber 150 and the exterior of the air receiving chamber 150 and can also provide the passage of air from within the air receiving chamber 150 to the exterior of the crankcase 105. In an alternative embodiment, the exhaust stem 170 can be a hose, such as a rubber hose.

FIG. 6 is an exploded view of an assembled mechanical breather system 135 in accordance with the present disclosure with respect to the engine crankcase 105. In FIG. 6, the assembled mechanical breather system 135 is illustrated without the associated crankshaft of the four-stroke engine 100. In an assembled configuration, the breather bearing 145 is received within an interior of the breather housing 155 such that a surface of the breather housing 155 is adjacent to the at least one inlet channel 310 of the rotating member 140. Bolts 600 can secure the breather housing 155 to the crankcase 105, which together with the connecting member (not shown) thereby secures the mechanical breather system 135 in place during operation of the four-stroke engine 100. In the assembled configuration, the exhaust stem 170 protrudes from the top of the breather housing 155 to expel the air and excess pressure from inside the crankcase 105.

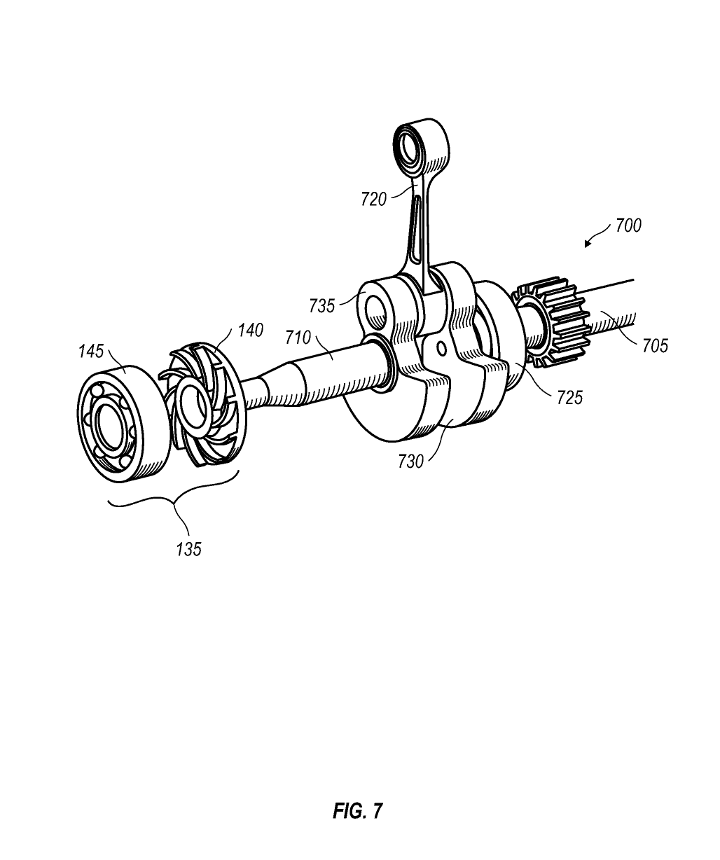

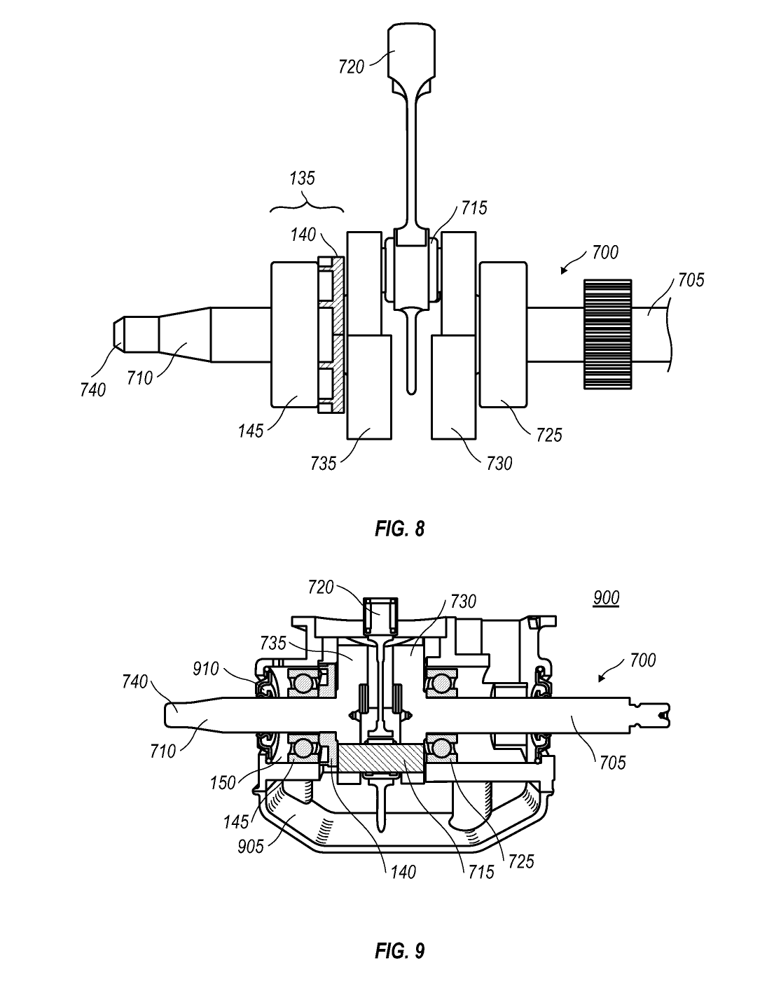

In an alternative embodiment, the mechanical breather system 135 can be configured as illustrated in FIGS. 7 and 8. FIG. 7 is a perspective view, and FIG. 8 is a side view of the mechanical breather system 135 in accordance with the present disclosure for the crankshaft 110 of a full-crank engine. The embodiment illustrated in FIGS. 7 and 8 is shown without the associated crankcase of the full-crank engine. The crankshaft 700 has a first portion 705 and a second portion 710 coupled together by a crankpin 715. The crankshaft 700 is supported by at least two bearings 725, 145. A connecting rod 720 is coupled to the crankpin 715 such that when a piston (not shown) associated with the connecting rod 720 reciprocates within a cylinder (not shown) of the full-crank engine, the crankshaft 700 will rotate within the crankcase. A first counterweight 730 can be coupled to the first portion 705 of the crankshaft 700 and can be positioned adjacent to the crankpin 715. A bearing 725 can also be coupled to the first portion 705 of the crankshaft 700 such that the bearing 725 is adjacent to the first counterweight 730 on the side opposite to the crankpin 715. The bearing 725 can be coupled to the crankcase such that the crankshaft 700 is supported for rotation within the crankcase. A second counterweight 735 can be coupled to the second portion 710 of the crankshaft 700 and can be positioned the crankpin 715. In FIGS. 7 and 8, the first counterweight 730 and the second counterweight 735 are positioned on opposite ends of the crankpin 715. The mechanical breather system 135 can be mounted to the second portion 705 of the crankshaft 700 adjacent to the second counterweight 735 on the side opposite to the crankpin 715. The rotating member 140 of the mechanical breather system 135 is positioned adjacent to the second counterweight 735. As illustrated in FIG. 8, the rotating member 140 is mounted on the crankshaft 700. In the illustrated embodiment, the rotating member 140 rotates in direct correspondence to rotation of the crankshaft 700. In other embodiments, the rotating member 140 can be configured to rotate at a different rate as compared to the crankshaft 700. The breather bearing 145 is positioned adjacent to the rotating member 140 on the side having the at least one inlet channel 310 as described above. In the illustrated embodiment of FIGS. 7 and 8, the breather bearing 145 is one of the at least two bearings 725, 145 supporting the crankshaft 700 to the crankcase. The at least two bearings 725, 145 can be configured to allow for fluid communication between the inner and outer races of the breather bearing 145. While the illustrated embodiment shows a breather bearing 145 and a bearing 725, one of ordinary skill in the art will appreciate that a third bearing can be used to support the crankshaft 700 to the crankcase in addition to the breather bearing 145. The second portion 710 of the crankshaft 700 can include a protruding end 740 which passes through the air receiving chamber 150 of the mechanical breather system 135. In other respects the mechanical breather 135 can be configured as described above.

FIG. 9 is a side cross-sectional view of the mechanical breather system 135 illustrated in FIG. 8 as it is assembled in a full-crank engine 900. The full-crank engine 900 can include a seal 910 for sealing the crankcase 905 and the protruding end 740 of the second portion 710 of the crankshaft 700. As illustrated, the seal 910 and the crankcase 905 can provide the air receiving chamber 150 positioned on the breather bearing 145 and opposite from the at least one inlet channel 310 of the rotating member 140. For example, the seal 910 and the crankcase 905 can form the wall of the air receiving chamber 150 on which the passage is disposed. The passage is then in fluid communication with the interior and the exterior of the air receiving chamber. In the illustrated example of FIG. 9, the passage can be space between the protruding end 740 of the crankshaft 700 and the seal of the crankcase 905. The crankcase cover 200 as described herein can be implemented with respect to the full-crank engine 900 as well. For example, the crankcase cover 200 can be sized to cover a portion of the crankcase 905. Alternatively, the crankcase cover 200 can be limited to just the fluid level window 210 that is mounted to the crankcase 905.

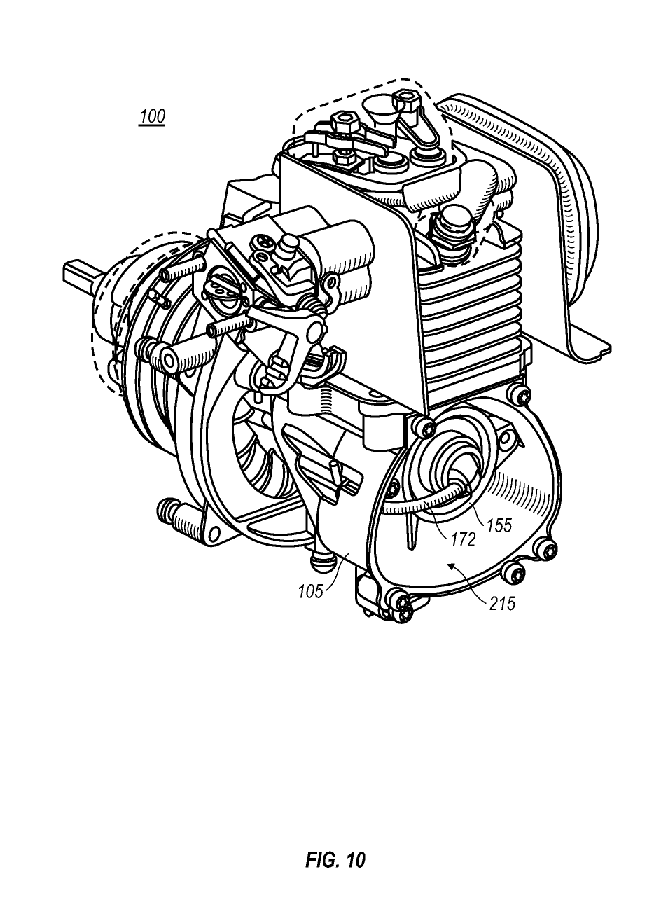

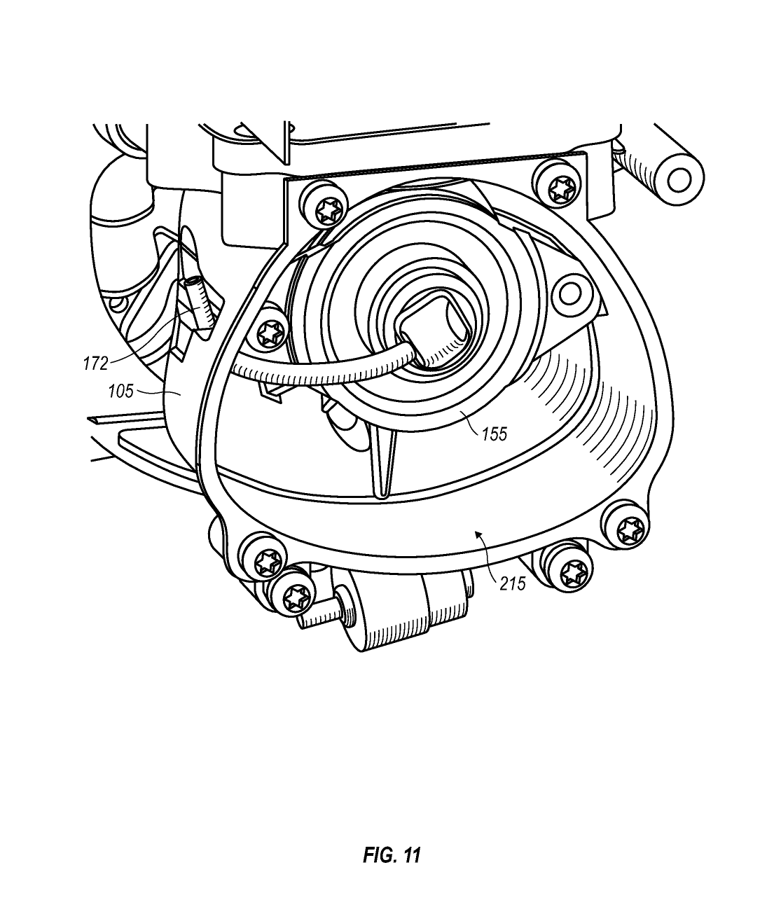

FIG. 10 is a perspective view of an exemplary four-stroke engine 100 assembled with a mechanical breather system 135 in accordance with an exemplary embodiment described herein. FIG. 11 is a partial view of the four-stroke engine 100 illustrated in FIG. 10. Specifically, FIG. 11 is a front view of the breather housing 155 of the crankcase, which is coupled to the mechanical breather system 135. In FIG. 11, the exhaust stem 170 extends from the interior of the air receiving chamber and passes through the top wall of the breather housing 155 towards the exterior of the air receiving chamber to expel the air and excess pressure of the crankcase 105. Additionally, the exhaust stem 170 connects to a hose which further carries the air towards an air intake portion of the engine 100.

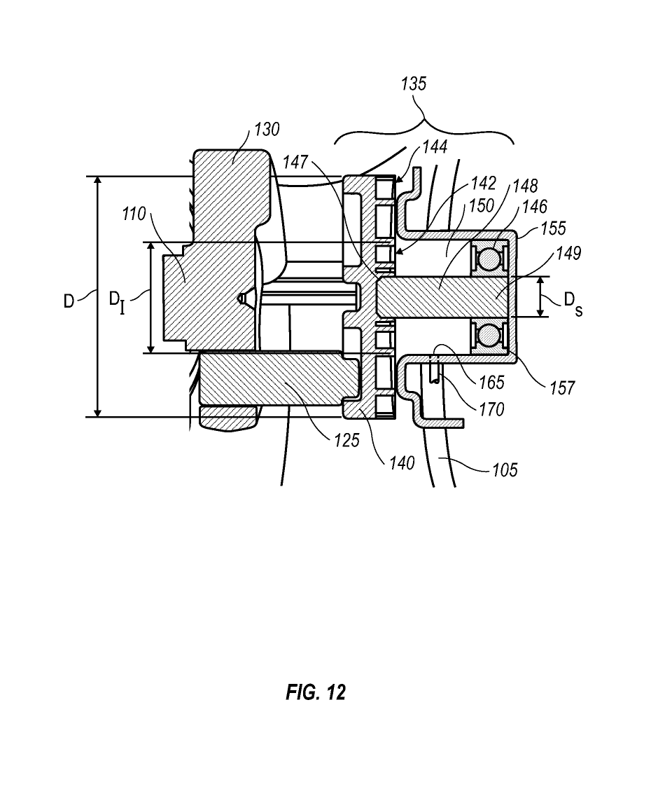

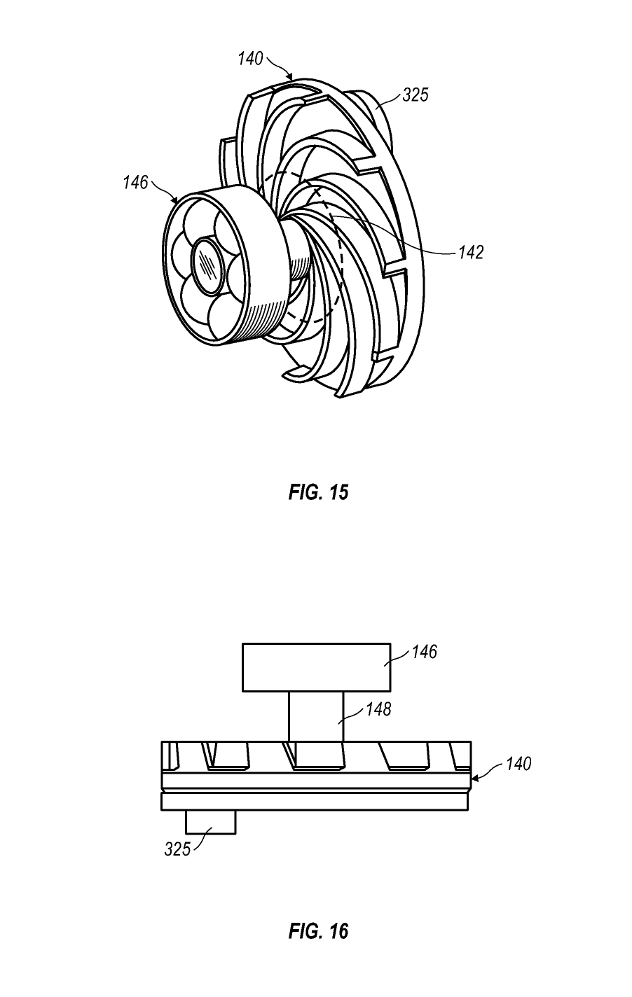

Another exemplary embodiment of a mechanical breather assembly according to the present disclosure is presented in FIGS. 12-16. While the mechanical breather assembly 135 as illustrated in FIGS. 12-16 is implemented on a half-crank engine, the mechanical breather assembly 135 can be implemented on a full-crank engine. As both the half-crank and full-crank engines have been illustrated above, FIG. 15 is a cross-section view of the breather assembly 135 and its coupling to the crankshaft 110. The rotating member 140 is coupled to the crankshaft 110. A connecting member 125 directly connects the crankshaft 110 to the rotating member 140. The connecting member 125 is shown as being coupled to the counterweight 130 of the crankshaft. Additionally, the rotating member 140 can be mounted on the crankshaft 110. For example, when the engine 100 is a full-crank engine, the rotating member 140 can have a through hole and a key receiving portion so as to couple the rotating member 140 to the crankshaft 110. While the illustrated embodiment uses a connecting member 125, the present disclosure contemplates that the rotating member 140 could be coupled directly or indirectly to the crankshaft 110. For example, other connecting members could be implemented whereby the angular acceleration and/or speed of the rotating member 140 can vary from the speed of the crankshaft 110.

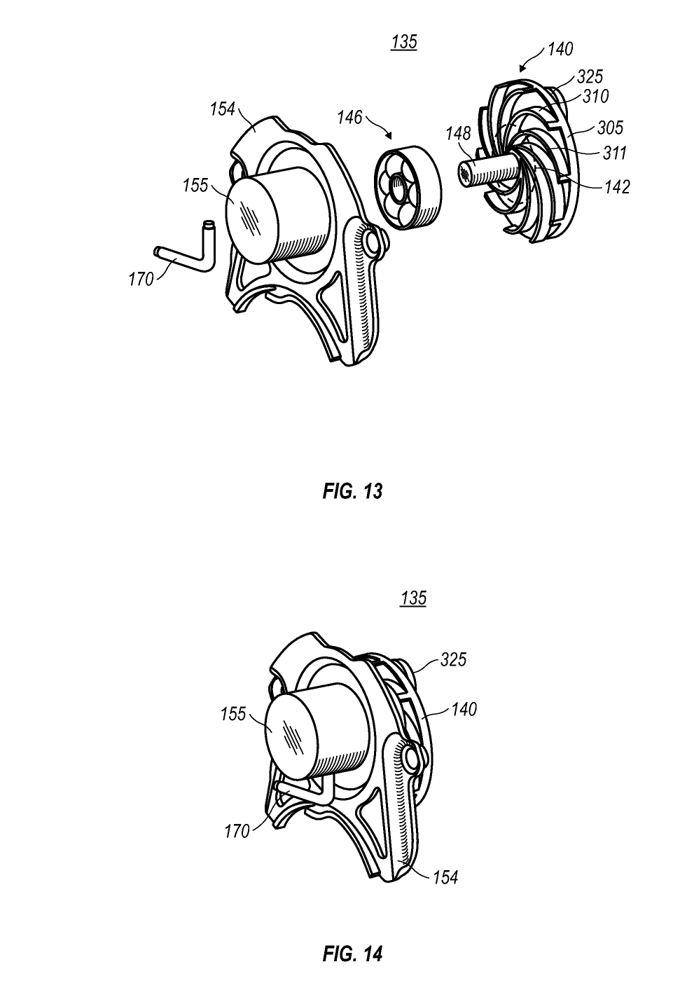

The rotating member 140 can be configured as described above. Namely, the rotating member 140 is configured so as to sling oil outward while allowing air to pass to the inner portion 142 of the rotating member. The rotating member 140 can include at least one inlet channel 310 (as described in regards to FIGS. 3 and 13). The inlet channel 310 as used herein can refer to a pathway for fluid communication between the outer perimeter 305 of the rotating member and an inner region 142 of the rotating member 140. The inlet channel 310 can be formed by one or more vanes 311 as illustrated. Further embodiments as described herein can also be implemented.

A breather housing 155 is coupled to engine 100 so that it is adjacent to the rotating member 140. The breather housing 155 has an air receiving chamber 150 formed therein. The air receiving chamber 150 is configured to receive air from the rotating member 140. As described above, as the rotating member 140 rotates it spins oil outward and allows the blow-by air to pass to an inner region 142 of the rotating member 140. The rotating member 140 is configured to allow fluid communication of air to the air receiving chamber 150. For example, as illustrated, when the rotating member 140 has at least one inlet channel 310, the inner portion of the at least one inlet channel 310, corresponding to the inner portion 142 of the rotating member 140, is in fluid communication with the air receiving chamber 150. The inner portion 142 of the rotating member 140 is configured to allow air to pass from the at least one inlet channel 310 to the air receiving chamber 150. In the illustrated embodiments, the at least one inlet channel 310 is open so as to allow the air to flow from the at least one inlet channel 310 to the air receiving chamber 150. In other embodiments, a plate or cover can be installed on the rotating member 140 to restrict to control the air flow to the air receiving chamber 150. For example, the plate can limit where along the at least one inlet channel 310 air is allowed to flow into the air receiving chamber 150.

While the description provided below is in relation to cylindrical areas and cross-sections, the rotating member 140, air receiving chamber 150 and other components can have non-cylindrical shapes. Additionally, other ratios and relative sizes of the components can be implemented as well. In the illustrated embodiment, the rotating member has a diameter that is larger than the diameter of the air receiving chamber 150. The relative ratio of the diameter to diameter of the air receiving chamber 150 allows for some separation of the oil from the air via the at least one channel of the rotating member. When the at least one channel 310 is open to the air receiving chamber 150, the relative sizes of the rotating member 140 and air receiving chamber 150 allow for the required separation of oil from air so that little or no oil is passed into the air receiving chamber 150. The relative ratio of the diameter as compared with diameter of the air receiving chamber can also dependent upon the diameter of the shaft 148 so that air flow into the air chamber 150 is sufficient. For example the ratio of diameter of the rotating member 150 to that the diameter of the air receiving chamber 150 can be two to one, three to one, three to two, or any other ratio. The ratio can depend upon the oil used and the size of the engine 100. Furthermore, the ratio can also depend upon the speed that the engine is designed to operate under normal conditions. While the above description is provided in relation to the diameters of the components, similar ratios of radiuses can also be made.

When the engine is a half-crank like the one illustrated, the rotating member 140 can be coupled to a to a rotating member shaft 148. The rotating member shaft 148 is coupled at a first end 147 to the rotating member 140. The second end 149 of the rotating member shaft 148 is coupled to a bearing 146. The rotating member shaft 148 can be removeably coupled at both the first end 147 and the second end 149. The rotating member shaft 148 provides for stabilization when the rotating member is turned by a half-crank engine. In other embodiments, the rotating member shaft can be removed if the rotating member is substantially supported in relation to the crankshaft such with a full-crank engine and the bearing 146 can provide support for the crankshaft (not shown).

The bearing 146 can be coupled to the bearing housing 155. As shown, the bearing is located on the opposite side of the air receiving chamber 150 from the rotating member 140. The bearing 146 is coupled to adjacent to an outside wall 157 of the breather housing 155. The outside wall 157 is substantially opposite and substantially parallel to the rotating member 140. The rotating member shaft 148 traverses the air receiving chamber 150.

The air from the rotating member 140 enters the air receiving member and is expelled via passage 165. The passage provides for coupling of an exhaust stem 170 that takes the air outside of the air receiving chamber.

FIG. 13 illustrates an exploded perspective view of the mechanical breather system 135. The mechanical breather assembly includes the rotating member 140, rotating shaft 148, bearing 146, breather housing 155, and an exhaust stem 170. The rotating member 140 as illustrated includes at least one inlet channel 310 extending between an outer perimeter 305 of the rotating member 140 and an inner region of the rotating member 140. As illustrated in FIG. 13, the at least one inlet channel 310 is curved between the outer perimeter 305 of the rotating member 140 and the center of the rotating member 140. However, the at least one inlet channel 310 can extend straight and radially from the center of the rotating member towards the perimeter 305 of the rotating member 140. Additionally, while FIG. 13 illustrates a rotating member 140 having ten inlet channels 310, the rotating member 140 can have two inlet channels, three inlet channels, seven inlet channels, thirteen inlet channels, or any number of inlet channels so long as the rotating member has at least one inlet channel 310. While the illustrated embodiment shows the at least one inlet channel 310 formed from a vane 311, the at least one inlet channel 310 can be an aperture through the rotating member 140 or can be a groove formed in the surface of the rotating member 140. Additionally, in the example shown, a plurality of vanes 311 are illustrated and thus a plurality of inlet channels 310 are illustrated. In the illustrated embodiment, ten vanes 311 are illustrated and are shaped with single cup shape along a single radius. In other embodiments, the vanes 311 can have multiple curvatures to encourage the flow of air in the at least one air inlet channel 310. Additionally, the rotating member 140 can include a socket 325 configured to receive a second end 149 of the connecting member 125. The socket 325 can be disposed on the face of the rotating member 140 that is opposite to the side having the at least one inlet channel 310. In other embodiments, the connecting member 125 can be coupled to the rotating member 140 through other mounting mechanisms such as a screw, bolt, threaded engagement and the like. In other embodiments, the connecting member 125 can be fixedly attached to the rotating member 140.

The bearing illustrated in FIG. 13 is an unsealed bearing having an inner race and an outer race. The unsealed configuration allows for passage of air between the inner race and outer race. In other embodiments, a sealed bearing can be implemented. When the sealed bearing is implemented it can also include a lubricant within the sealed bearing.

The breathing housing 155 can be formed to an integral engine cover 154. When the breather housing is formed as part of the engine cover 154, the engine cover can be coupled to the engine using removable fasteners such as bolts, screws, and pins. Additionally, a seal can be included that prevents air or other fluids from escaping the engine cavity.

Additionally, the inner portion 142 of the rotating member 140 is illustrated in FIG. 13. As illustrated, the inner portion 142 is shown in dashed lines. As discussed above, the inner portion 142 is the portion of the rotating member 140 that can be in fluid communication with the air receiving chamber 150. The channels 310 of the rotating member can be enclosed until they reach the inner portion 142 of the rotating member 140. In other embodiments, an additional member can be included that prevents the flow of air from the rotating member 140 to the air chamber 150 until it reaches the inner portion 142 of the rotating member 140. For example, the additional member can be a plate with apertures.

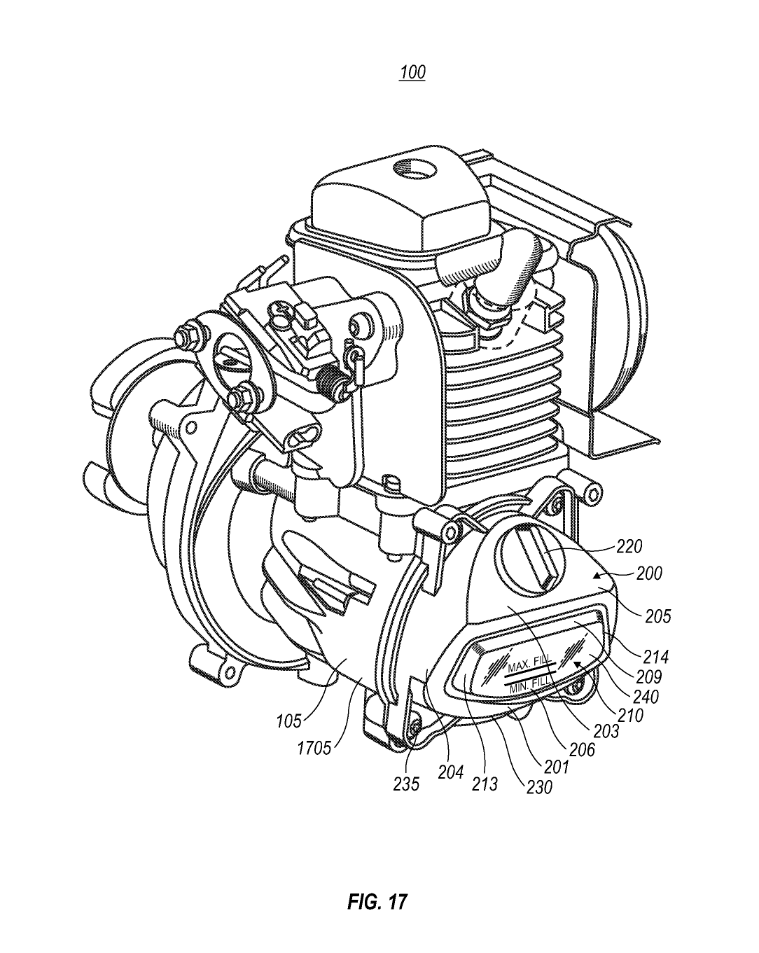

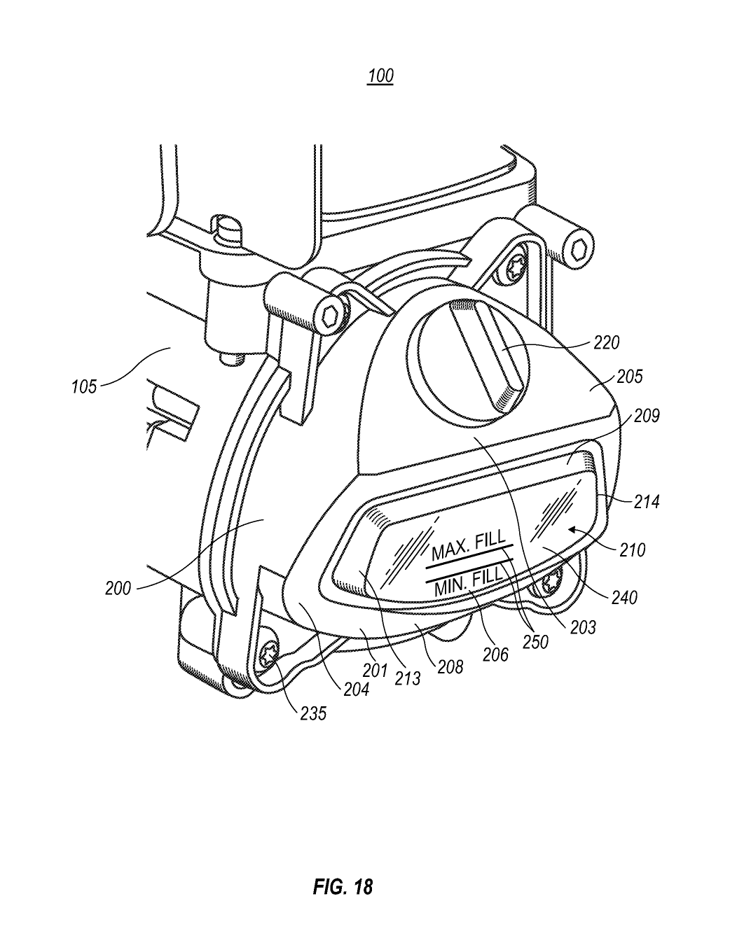

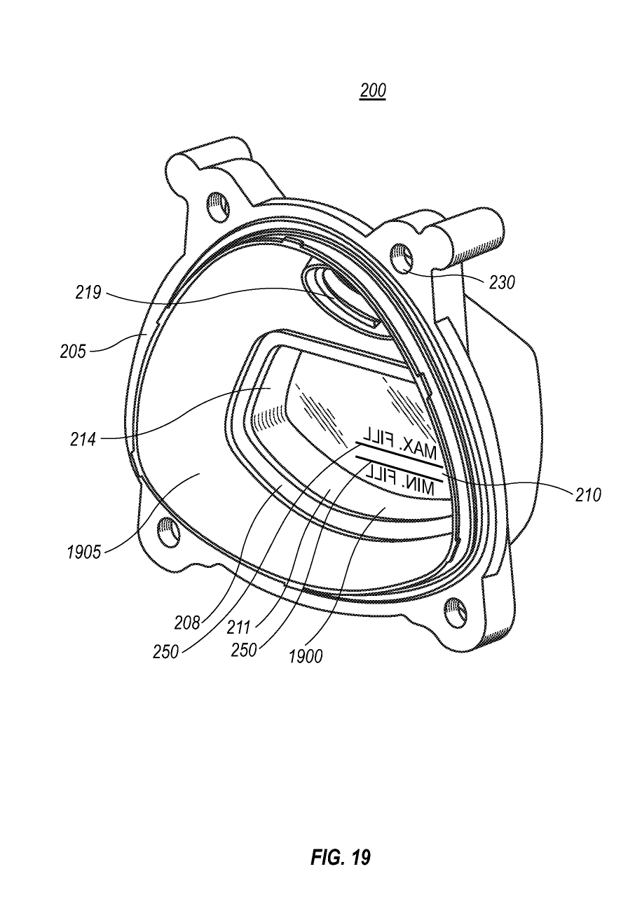

FIG. 17 illustrates the assembled perspective view of an engine 100 having a crankcase cover 200 coupled to the crankcase 105. As illustrated in FIG. 17, the crankcase cover 200 is fastened onto the crankcase 105 such that the fluid level window 210 of the crankcase cover 200 provides a visible window through which the level of lubricant in the crankcase can be viewed. FIG. 18 is a partial perspective view of the engine 100 illustrated in FIG. 17. More specifically, FIG. 18 is a close-up view of the crankcase cover 200 illustrated in FIG. 17. In FIG. 18, the fluid level window 210 extends beyond the body portion 205 of the crankcase cover 200. As illustrated, the fluid level window 210 extends away from the crankcase 105. As the fluid level window 210 extends beyond the body portion 205, light can pass through the fluid level window 210 thereby lighting the interior of the fluid level window 210 and enhancing the visibility of the level of the lubricant in the crankcase 105 and/or fluid level window.

Also, as the fluid level window 210 extends beyond the body portion 205, the volume of the crankcase 105 is increased by the distance that the fluid level window 210 extends beyond the body portion 105. Thus, an additional amount of lubricant can be contained in the crankcase 200 in the cavity 1900 (shown in FIG. 19) defined by the fluid level window 210 extending beyond the body portion 205. In at least one embodiment, the lubricant or fluid within the crankcase 105 is in fluid communication with the fluid level window 210 so that the fluid level (for example, lubricant level) can be seen through the fluid level window 210.

FIGS. 17 and 18 also illustrate the contour of the crankcase cover 200. As illustrated in FIGS. 17 and 18, the body portion 205 has an exterior face 201, 203, 204. The exterior face includes a first portion 203 (for example an upper portion), a second portion 201 (for example a lower portion), and a third portion 204 (for example, the sides). The first portion 203 and the second portion 201 can each be sloped. For example, the first portion 203 can be sloped in a first direction, and the second portion 201 can be sloped in a second direction. In one embodiment, the direction of the sloped first portion 203 and direction of the sloped second portion 201 can be in opposite directions. In another embodiment, the sloped first portion 203 and the sloped second portion 201 can intersect such that the intersection of the first portion 203 and the second portion 201 is at a point or portion furthest away from the crankcase 105. The body portion 205 has an exterior face (201, 203, 204), wherein the exterior face (201, 203, 204) has a bottom 230 and the bottom 230 is curvilinear and has substantially the same curvature as the crankcase 105.

As illustrated in FIGS. 17 and 18, the first portion 203 can define the plug receiving hole 219 (shown in FIG. 2). For example, the plug receiving hole 219 (shown in FIG. 2) can be a lubricant fill, an aperture for an oil fill plug, or other opening through which a lubricant cap or plug can be received. The second portion 201 can define a hole configured to receive the fluid level window 210. The fluid level window 210 can be coupled to the second portion 201 of the body portion 205, as described above with respect to FIG. 2, for example. As illustrated in FIGS. 17 and 18, the third portion 204 (for example, the side portions) is also sloped.

As the contours of the fluid level window 210 and the body portion 205 are sloped, the lubricant poured through the plug receiving hole 219 is directed towards the bottom of the crankcase 105. Furthermore, the sloped orientations of the fluid level window 210 and the body portion 205 can increase the volume of the cavity defined by the crankcase cover 200 and the crankcase 105, thereby increasing the volume capacity of the crankcase 105 for holding lubricant. Thus, more lubricant can reside within the crankcase 105, thereby ensuring an adequate amount of lubricant resides in the crankcase 105 to allow the engine to operate.

As illustrated in FIGS. 17 and 18, the fluid level window 210 includes sides 209, 211, 213, 214. In the particular embodiment illustrated in FIGS. 17 and 18, the fluid level window 210 includes a top 209, a bottom 211 (shown in FIGS. 2, 19, and 21), a left side 213 and a right side 214. As illustrated in FIGS. 17 and 18, the fluid level window 210 is contoured to be substantially similar to the contour of the body portion 205. For example, the proximal ends of the left side 213 and right side 214 are sloped to match the slope of the body portion 205. In another embodiment, the left side 213 and the right side 214 can be curvilinear. Also illustrated in FIGS. 17 and 18, the top side 210 can be shorter than the bottom side 211. For example, the top side 209 can have a top width, and the bottom side 211 can have a bottom width. The top width can be narrower than the bottom width, thereby making the top side 209 shorter than the bottom side 211. As the bottom side 211 of the fluid level window 210 is wider than the top side 209, fluid or lubricant can accumulate in the cavity formed at the bottom side 211 of the fluid level window 210, thereby providing a visual indication of the level of lubricant within the crankcase 105. In another embodiment, the bottom side 211 can be curvilinear, for example as illustrated in FIGS. 17-20. For example, the curvilinear shape of the bottom side 211 can be such that the bottom side 211 has a radius of curvature that substantially matches a radius of curvature of a bottom side 1705 of the crankcase 105. When the bottom side 211 is curvilinear it can exhibit increased performance for example by providing a easier to read level. Additionally, the contour of the body portion 205 fluid level window 210 can enhance the visibility through the fluid level window 210 to allow an operator to measure the amount of lubricant within the crankcase 105. For example, the sloped contour of the body portion 205 and the fluid level window 210 can direct ambient light into the cavity formed by the crankcase cover 200, thereby providing an interior light that allows the operator to distinguish the lubricant from the empty space within the crankcase 105. In other words, the illumination provided by the contour of the body portion 205 and the interior portion 210 can enhance the visibility of the level of lubricant within the crankcase 105.

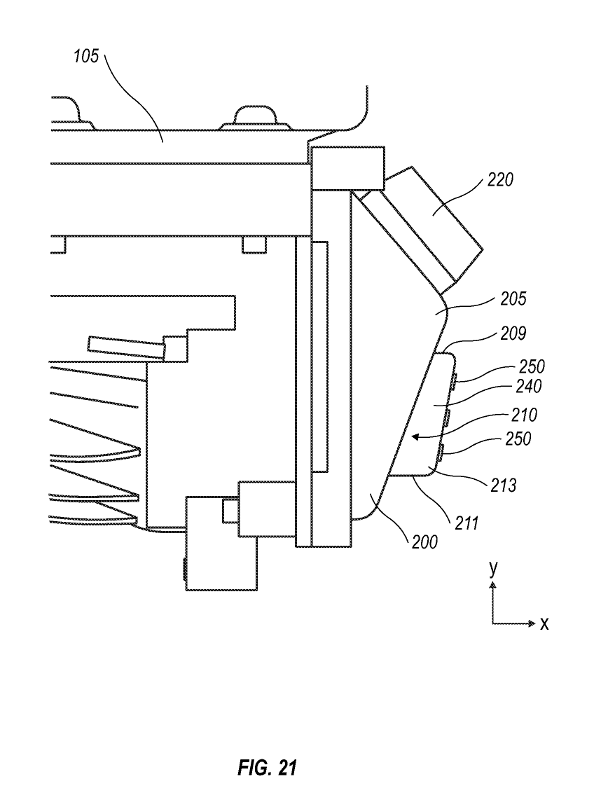

Also illustrated in FIGS. 17 and 18, the fluid level window 210 includes a substantially flat portion 240. For example, the substantially flat portion 240 can be at the distal end 206 of the fluid level window 210. The substantially flat portion 240 can bear fluid level indicators 250 (illustrated in FIG. 21). Further details as to the fluid level indicators 250 will be described with respect to FIG. 21.

FIG. 19 is a rear view of the crankcase cover 200 in accordance with the present disclosure. FIG. 19 illustrates the cavity 1900 defined by the fluid level window 210 extending beyond the body portion 205 of the crankcase cover 200. In at least one embodiment, the body portion 205 can also extend a distance from the crankcase 105, when the crankcase cover 200 is assembled with the crankcase 105. A body portion cavity 1905 can be defined by the body portion 205 extending a distance from the crankcase 105, thereby providing another cavity which can accommodate an additional volume of lubricant for the crankcase. The body portion cavity 1905 can also provide an additional space to accumulate light passing through the fluid level window 210, thereby providing further illuminating light to make the level of lubricant visible through the fluid level window 210. Also illustrated in FIG. 19 are the connecting apertures 230 through which a coupling component 235 (illustrated in FIG. 18) can be inserted. For example, the coupling component 235 can be a screw, a bolt, or other component which can secure the crankcase cover 200 to the crankcase 105. In FIG. 19, the body portion 205 has four connecting apertures 230 that are ear portions; however, fewer or more connecting apertures 230 can be provided to secure the body portion 205 of the crankcase cover 200 to the crankcase 105. For example there can be three ear portions. In other embodiments, only one or two ear portions can be implemented as well.

FIG. 20 illustrates a front view of the crankcase cover 200 in accordance with the present disclosure. In FIG. 20, the crankcase 105 can have a length that is parallel to the crankshaft (not labeled). The crankcase 105 can also have a crankcase width 2005 that is perpendicular to the crankshaft 105. The crankcase cover 200 can have a crankcase cover width 2015 that is perpendicular to the crankshaft 105. The fluid level window 210 can span more than sixty percent of the width of the crankcase 105, as illustrated in FIG. 18. In other words, the fluid level window 210 can have a fluid level window width 2025 that spans more than sixty percent of the crankcase cover width 2015. As the fluid level window 210 spans more than sixty percent of the crankcase 105, a large fluid level window 210 can be provided through which the level of lubricant in the crankcase 105 can be seen. In another embodiment, the fluid level window 210 can span a substantial entirety of the crankcase cover width 2015; however, the fluid level window 210 can span less than the entirety of the crankcase cover with 2015, so long as the fluid level window width 2025 is large enough to allow the operator of the tool to view the level of the lubricant within the crankcase 105.

Also illustrated in FIG. 20, the fluid level window 210 can have a fluid level window height 2020 that is parallel to the crankcase cover height 2010. The fluid level window height 2020 can span less than thirty percent of the crankcase cover height 2010. However, in other embodiments, the fluid level window height 2020 can span less than twenty percent of the crankcase cover height 2010, or any other percentages of the crankcase cover height 2010, so long as the level of lubricant within the crankcase 105 can be measured and viewed though the fluid level window 210.

The fluid level window 210 can have a fluid level window height 2020 and a fluid level window width 2025. In at least one embodiment, the fluid level window width 2025 can be at least two times the fluid level window height 2020. In another embodiment, the fluid level window width 2025 can be at least four times the fluid level window height 2020. Having the fluid level window width 2025 greater than the fluid level height 2020 allows the operator to know if the fluid is level in the crankcase 105 so that a more accurate reading can be made.

As illustrated in FIG. 20, the fluid level window 210 has a trapezoidal-like shape that extends perpendicularly to the body portion 205. However, in other embodiments, the fluid level window 210 can have a rectangular shape, an ovular shape, or any other shape that allows the fluid level window 210 to extend from the body portion 205. As shown the substantially flat portion 240 can have a flat portion height 2030 and a flat portion width 2035. In this embodiment, the flat portion height 2030 is less than fluid level window height 2020 and the flat portion width 2035 is less than the fluid level window width 2025. In other embodiments, different shapes are possible such that the flat portion 204 might have the same width and height as of the fluid level window 210.

Additionally, as illustrated the fluid level window 210 includes two fluid level indicators 250. While only two fluid level indicators 250 are shown, other examples of the present disclosure can include more than two fluid level indicators 250. As illustrated the two fluid level indicators include a maximum fill indicator 249 and a minimum fill indicator 251. In one example, the two fluid level indicators 250 are spaced apart by a distance 221 that is greater than one eighth of the fluid level window height 2030. In another example, the two fluid level indicators 250 are spaced apart by a distance 221 that is greater than one fourth of the fluid level window height 2030.

FIG. 21 is a side view of an engine assembled with a crankcase cover 200 in accordance with the present technology. FIG. 21 further illustrates the protruding or extending relationship between the body portion 205 and the fluid level window 210 of the crankcase cover 200. As described above, the fluid level window 210 can include a substantially flat portion 240. The substantially flat portion 240 can be located at the distal end 206 of the fluid level window 210. The substantially flat portion 240 can bear fluid level indicators 250 thereon. In at least one embodiment, lubricant within the crankcase 105 is in fluid communication with the fluid level window 210 of the crankcase cover 200 such that the level of lubricant within the crankcase 105 can be seen in relation to the fluid level indicators 250 on the substantially flat portion 240 of the distal end 206 of the fluid level window 210. In FIG. 21, the fluid level indicators 250 can signify at least two different levels of lubricant within the crankcase 105. For example, the two different levels can be a maximum fill indicator 249 (illustrated as a Max. Fill) and a minimum fill indicator 251 (illustrated as a Min. Fill). Therefore, the operator of the engine 100 can view the fluid level window 210 and measure the level of lubricant visible through the fluid level window 210 with respect to the fluid level indicators 250 on the substantially flat portion 240 of the fluid level window 210. If the level of the lubricant matches the fluid level indicator 250 corresponding to the maximum fill indicator 249, the operator knows that a sufficient level of lubricant resides within the crankcase 105. If the level of the lubricant matches the fluid level indicator 250 corresponding to the minimum fill indicator 251, the operator is notified that additional lubricant should be added to the crankcase 105. If, however, the level of the lubricant is between the fluid level indicators 250 corresponding to the maximum fill indicator 249 and minimum fill indicator 251, the operator can determine that an adequate level of lubricant resides in the crankcase 105 to operate the engine 100. If the level of the lubricant exceeds the fluid level indicator 250 corresponding to the maximum fill indicator 249, the operator knows that a too much lubricant resides within the crankcase 105.

In another example, the fluid level indicators 250 can be provided on the body portion 205 adjacent to the left side 213 or right side 213 of the fluid level window 210. Additionally, the fluid level window 210 can include information regarding the proper lubricant to be used.

With the crankcase cover 200 described herein, the level of lubricant residing in the crankcase 105 can be readily seen by the operator of the engine via the fluid level window 210 of the crankcase cover 200. As the fluid level window 210 can include fluid level indicators 250 to signify the level of lubricant residing in the crankcase 105, a conventional lubricant dipstick is not necessary. Additionally, the translucency of the fluid level window 210 and the shape and extension of the fluid level window 210 with respect to the body portion 205 enhances the illumination of the crankcase 105 and the angle of visibility into the crankcase 105, thereby enhancing the accuracy of determining the level of lubricant residing in the crankcase 105. Furthermore, in at least one embodiment, as the fluid level window 210 extends beyond the body portion 205 of the crankcase cover 200, the fluid level window 210 is further away from the oil slinging arm 190. Therefore, the fluid level window 210 is less likely to be splashed with lubricant from the oil slinging arm 190 which could skew or alter the reading of the level of lubricant residing in the crankcase 210, as the splashed lubricant covering the fluid level window 210 can be mistaken as the actual level of lubricant residing in the crankcase 105.

FIG. 22 illustrates a cross-sectional assembly view of the engine 100 including a crankcase cover 200, an oil fill plug 220, and a fluid level window 210. As shown the oil fill plug 220 can be configured to be received by the plug receiving hole 219. As illustrated the, oil fill plug 220 and plug receiving hole 219 are threaded. In other embodiments, the oil fill plug 220 and plug receiving hole can be configured such that they can be releasably coupled for example through a friction fit, a taper fit, or other releasable fastening mechanism.

The body portion 205 of the crankcase cover 200 defines a through hole 216 which is configured to receive the fluid level window 210. As shown the fluid level window includes receiving portions 212 which receive protrusions 207 of the body portion 205 of the crankcase cover 200. In at least the illustrated embodiment, the fluid level window 210 can include a proximal end 208 and a distal end 206. The proximal end 208 can be formed of the same material as the fluid level window 210. An endcap 240 or flat portion can be located at the distal end 206 of the fluid level window 210. The fluid level window 210 can also include sides 209, 211. The sides 209, 211 can extend perpendicular to the endcap 240 towards the proximal end 208 of the fluid level window 210. As illustrated, the flat portion 240 of the fluid level window 210 extends beyond the crankcase cover body portion 205. In other examples as illustrated below, the fluid level window 210 can be configured to be flush or recesses as compared with the body portion 205. Additionally, in at least another embodiment, the body portion 205 of the crankcase cover 200 can include a recess in which the fluid level window is mounted.

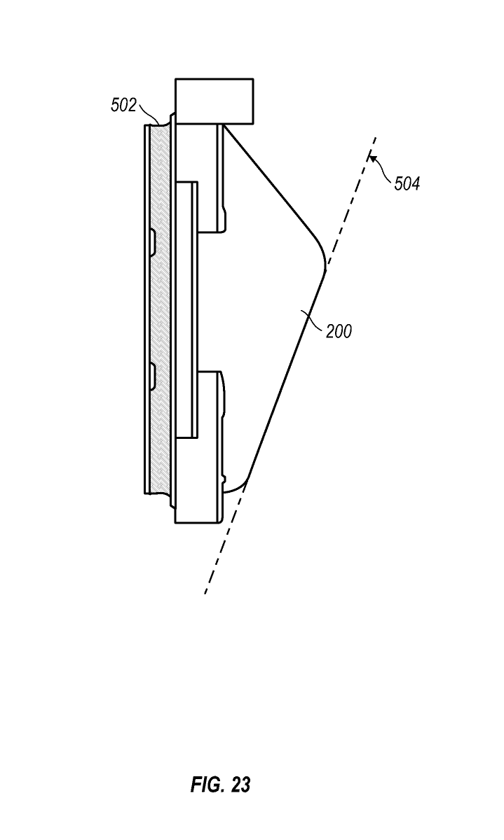

FIG. 23 is side profile view of another example of a crankcase cover 200 in accordance with an exemplary embodiment of the present disclosure. As illustrated in the side profile view of the crankcase cover 200, the lower portion of the crankcase cover does not extend beyond the line 504. The fluid level window 210 as illustrated in some of the preceding examples extended beyond the line 504. In at least one example, the fluid level window 210 can be substantially parallel to the line 504. In another example, the fluid level window 210 can be recessed such that it does not extend beyond the line 504. Additionally, the crankcase cover 200 can include a seal 502.

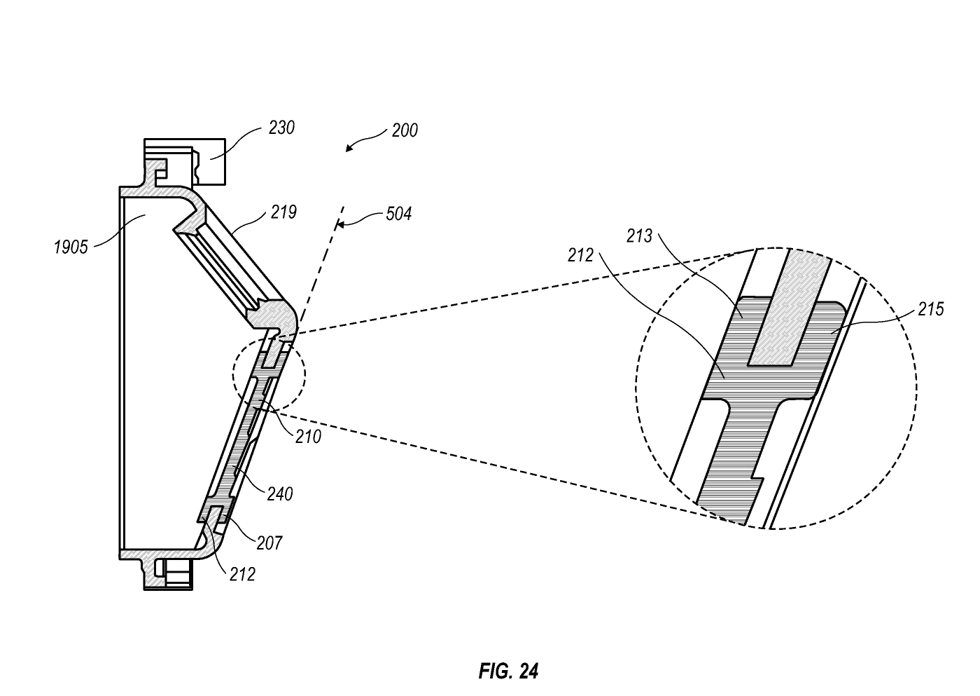

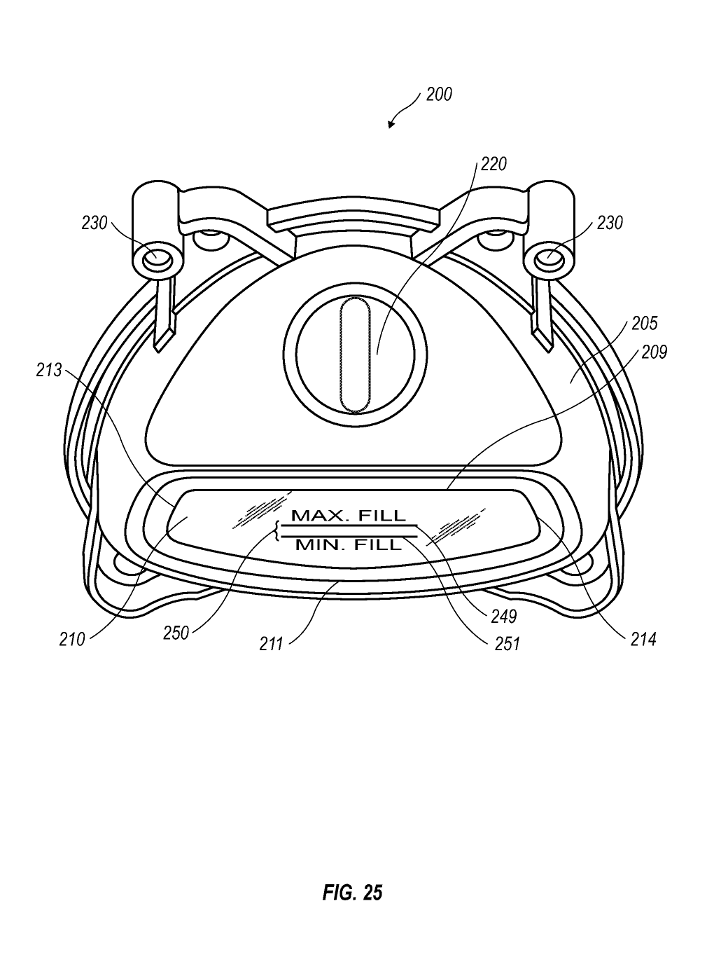

FIG. 24 is a cross-sectional view of another example of a crankcase cover 200 in accordance with an exemplary embodiment of the present disclosure. As illustrated the crankcase cover 200 includes a plug receiving hole 219, a body cavity portion 1905, and connecting apertures 230.

As illustrated, the fluid level window 504 does not extend beyond the line 504 which defines the extent to which the crankcase cover 200 extends. As illustrated, the substantially flat portion 240 of the fluid level window 210 is recessed from the line 504. In other embodiments, the substantially flat portion 240 can be substantially flush with line 504 and in turn the crankcase cover 200. In other embodiments, a further recess can be established in the crankcase cover in which the fluid level window 210 is housed.

The crankcase cover 200 includes protrusions 207 which are configured to be engaged with receiving portions 212 of the fluid level window 210. As shown in the detail view of FIG. 24, the receiving portions 212 can be formed such that there is an inner receiving portion 213 and an outer receiving portion 215, thereby forming a channel to receive the protrusions 207 of the crankcase cover 200. In other embodiments, the crankcase cover 200 can be formed to include receiving portions and the fluid level window 210 can include protrusions. As described above, other arrangements for fastening the fluid level window 210 to the crankcase cover 200 are considered within the scope of this disclosure. For example, the fluid level window 210 can be coupled to the crankcase cover 200 via one or more fasteners.

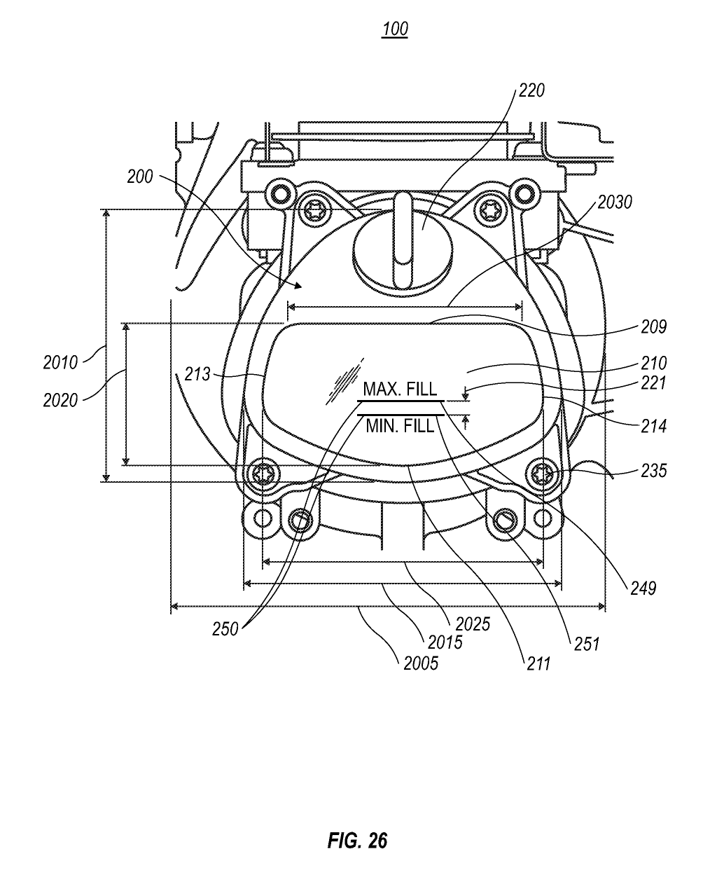

FIG. 25 is perspective view of another example of a crankcase cover in accordance with an exemplary embodiment of the present disclosure. As illustrated, the oil fill plug 220 is located above the fluid level window 210. As illustrated, the fluid level indicators 250 can signify at least two different levels of lubricant within the crankcase 105. For example, the two different levels can be a maximum fill indicator 249 and a minimum fill indicator 251, as described above.

FIG. 26 is a side profile view of an exemplarily four-stroke engine assembled with another example of a crankcase cover 200 in accordance with an exemplary embodiment. In FIG. 26, the crankcase 105 can have a length that is parallel to the crankshaft (not labeled). The crankcase 105 can also have a crankcase width 2005 that is perpendicular to the crankshaft 105. The crankcase cover 200 can have a crankcase cover width 2015 that is perpendicular to the crankshaft 105. The fluid level window 210 can span more than sixty percent of the width of the crankcase 105. Alternatively, the fluid level window 210 can have a fluid level window width 2025 that spans more than sixty percent of the crankcase cover width 2015. As the fluid level window 210 spans more than sixty percent of the crankcase cover width 2015 a large fluid level window 210 can be provided through which the level of lubricant in the crankcase 105 can be seen. In another embodiment, the fluid level window 210 can span a substantial entirety of the crankcase cover width 2015; however, the fluid level window 210 can span less than the entirety of the crankcase cover with 2015, so long as the fluid level window width 2025 is large enough to allow the operator of the tool to view the level of the lubricant within the crankcase 105.

Also illustrated in FIG. 26, the fluid level window 210 can have a fluid level window height 2020 that is parallel to the crankcase cover height 2010. The fluid level window height 2020 can span less than thirty percent of the crankcase cover height 2010. However, in other embodiments, the fluid level window height 2020 can span less than twenty percent of the crankcase cover height 2010, or any other percentages of the crankcase cover height 2010, so long as the level of lubricant within the crankcase 105 can be measured and viewed though the fluid level window 210.

The fluid level window 210 can have a fluid level window height 2020 and a fluid level window width 2025. In at least one embodiment, the fluid level window width 2025 can be at least two times the fluid level window height 2020. In another embodiment, the fluid level window width 2025 can be at least four times the fluid level window height 2020. Having the fluid level window width 2025 greater than the fluid level height 2020 allows the operator to know if the fluid is level in the crankcase 105 so that a more accurate reading can be made.

As illustrated in FIG. 26, the fluid level window 210 has a trapezoidal-like shape that extends perpendicularly to the body portion 205. However, in other embodiments, the fluid level window 210 can have a rectangular shape, an ovular shape, or any other shape that allows the fluid level window 210 to extend from the body portion 205.

Additionally, as illustrated the fluid level window 210 includes two fluid level indicators 250. While only two fluid level indicators 250 are shown, other examples of the present disclosure can include more than two fluid level indicators 250. As illustrated the two fluid level indicators include a maximum fill indicator 249 and a minimum fill indicator 251. In one example, the two fluid level indicators 250 are spaced apart by a distance 221 that is greater than one eighth of the fluid level window height 2030. In another example, the two fluid level indicators 250 are spaced apart by a distance 221 that is greater than one fourth of the fluid level window height 2030.

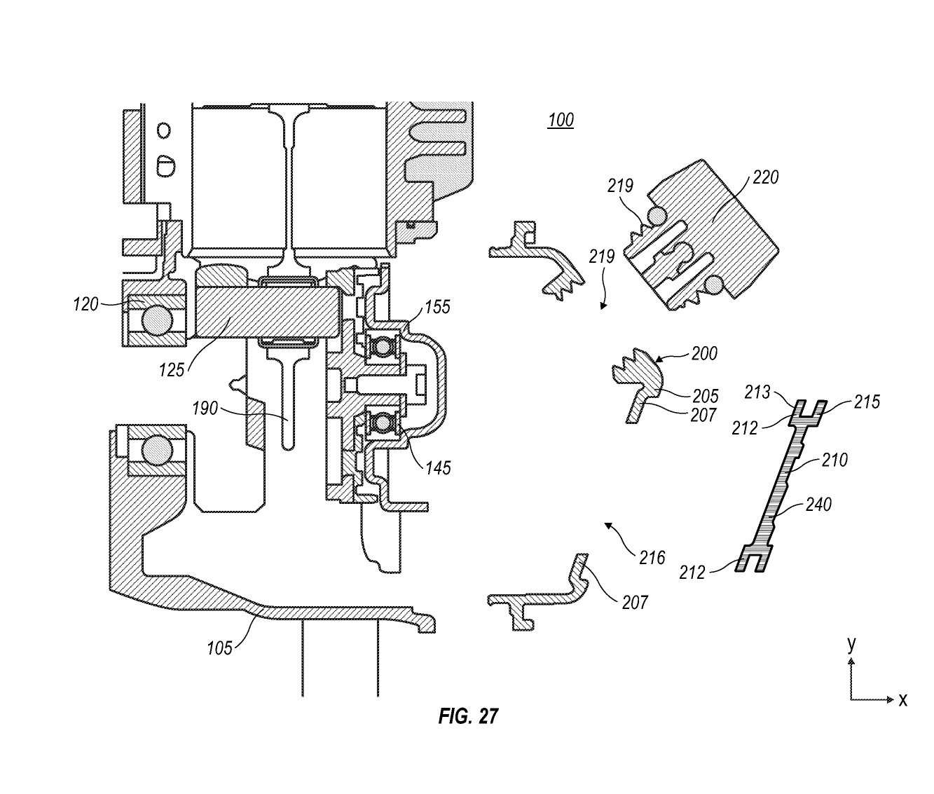

FIG. 27 is a cross-sectional assembly view of another example of a crankcase cover in accordance with an exemplary embodiment of the present disclosure. The cross-sectional assembly view of the engine 100 includes a crankcase cover 200, an oil fill plug 220, and a fluid level window 210. As shown the oil fill plug 220 can be configured to be received by the plug receiving hole 219. As illustrated the, oil fill plug 220 and plug receiving hole 219 are threaded. In other embodiments, the oil fill plug 220 and plug receiving hole can be configured such that they can be releasably coupled for example through a friction fit, a taper fit, or other releasable fastening mechanism.

The body portion 205 of the crankcase cover 200 defines a through hole 216 which is configured to receive the fluid level window 210. As shown the fluid level window 210 includes receiving portions 212 which receive protrusions 207 of the body portion 205 of the crankcase cover 200. As illustrated the receiving portions 212 include an inner receiving portion 213 and an outer receiving portion 215. The inner receiving portion 213 is within the crankcase cover 200 and is in fluid communication with the fluid located within the crankcase 105. The outer receiving portion 215 is on the outside of crankcase cover 200. While in the illustrated embodiment, the body portion 205 of the crankcase cover is illustrated to have protrusions 207 and the fluid level window 210 has receiving portions 212, other embodiments can be configured such that receiving portion is on body portion 205 of the crankcase cover 200 and the protrusions are on the fluid level window 210. In yet other embodiments, the configuration of the fluid level window 210 and the body portion 205 can have a mixed arrangement of receiving portions and protrusions. For example, the protrusions and receiving portions can be configured such that the fluid level window can only be installed in a specific configuration.

As illustrated, the flat portion 240 of the fluid level window 210 is inset from the outer receiving portions 215. In other embodiments, the flat portion 240 can be level with the outer receiving portions 215 such that the outer most portion of the fluid level window 210 is substantially flat. In other embodiments, the outer most portion of the fluid level window 210 can have at least a partially raised or recessed surface. For example, the outer portion of the fluid level window 210 can have fluid level indicators engraved there in.

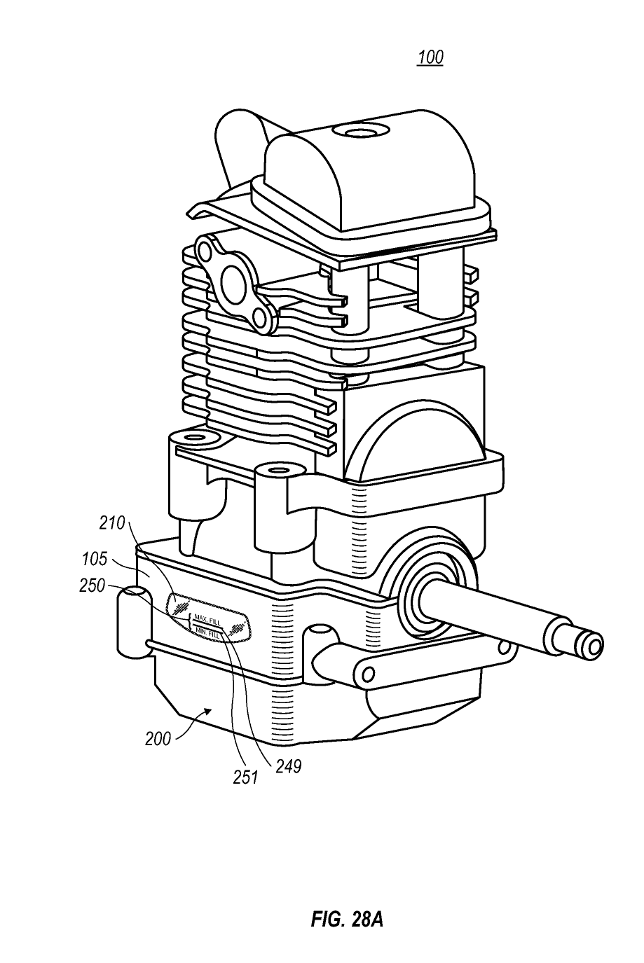

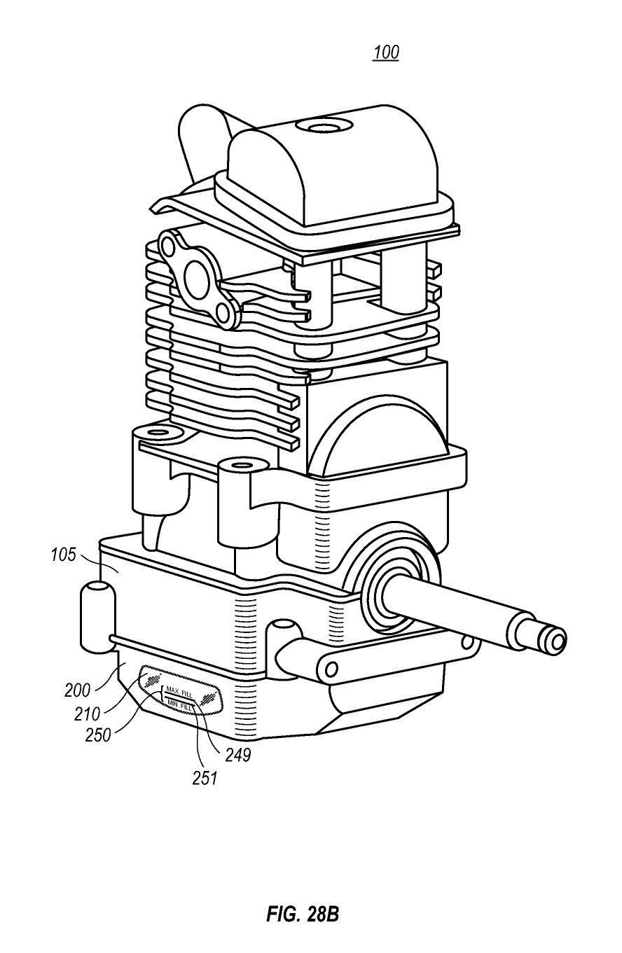

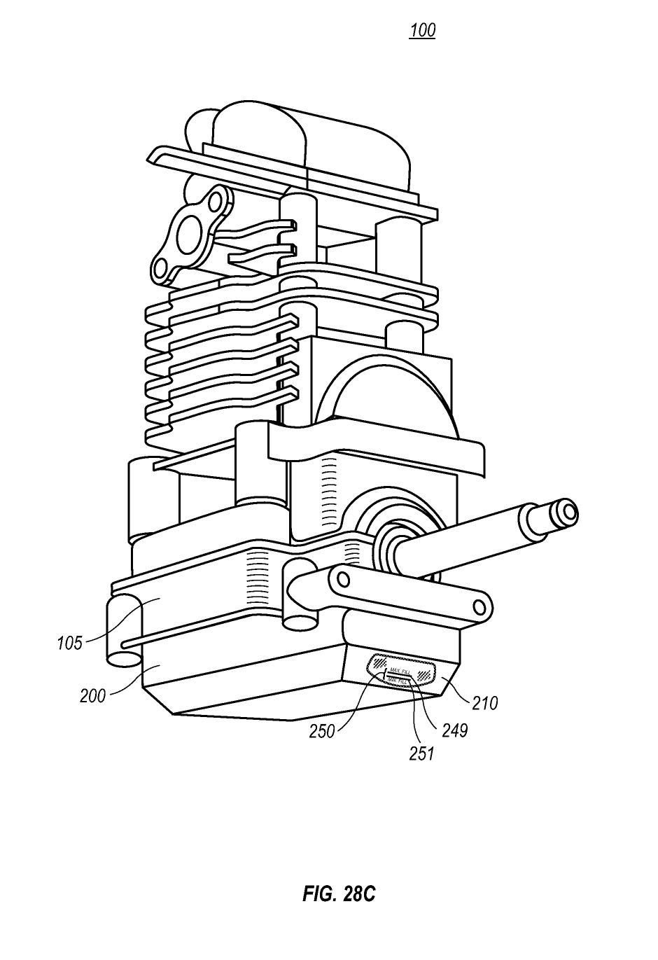

FIGS. 28A-C illustrate three different examples of a fluid level window 210 implemented on a full crank engine 100. The full crank engine 100 includes a crankcase 105 which further includes at least one crankcase cover 200. The fluid level window 210 can be placed on the crankcase 105 in different positions according to the present disclosure. The placement of the fluid level window 210 is such that it can be seen by an operator and gives an accurate reading of the fluid level in the crankcase 105. As illustrated in FIG. 28A, the fluid level window 210 is located on the crankcase 105 and includes at least one indicator 250. As shown, the at least one indicator includes two indicators namely a maximum fill indicator 249 and a minimum fill indicator 251. The at least one indicator 250 can be printed on the fluid level window 210. In another example, the at least one indicator 250 can be formed integrally with the fluid level window 210. In yet another example, the at least one indicator 250 can be molded with the at least one indicator 250.

In FIG. 28B, the fluid level window 210 is located on the crankcase cover 200 in a first position. In FIG. 28C, the fluid level window 210 is located on the crankcase cover 200 in a second position. The position of the fluid level window 210 can be such so as to allow determination of the fluid level in the crankcase 105. In at least one embodiment, multiple fluid level windows 210 can be implemented on the crankcase cover 210. In at least one example, the fluid level window 210 can be positioned on each visible side of the crankcase cover 200. In yet another embodiment, when the crankcase 105 including the crankcase cover 200 are hidden beneath other layers of material an extension can be provided so that the fluid level window 210 is separate from the crankcase 105 and externally visible.

Exemplary embodiments have been described hereinabove regarding a crankcase cover for a four-stroke engine. The crankcase cover described herein can be used in relation to any type of four-stroke engine, such as a half-crank four-stroke engine, a full-crank four-stroke engine, a four-stroke engine for an outdoor power tool such as a blower, trimmer or the like, a small four-stroke engine for a motored bike or scooter, or any other four-stroke engine that requires ventilation of crankcase pressure.

One of ordinary skill in the art will appreciate that the features in each of the figures described herein can be combined with one another and arranged to achieve the described benefits of the presently disclosed crankcase cover. Additionally, one of ordinary skill will appreciate that the elements and features from the illustrated embodiments herein can be optionally included to achieve the described benefits of the presently disclosed crankcase cover. Various modifications to and departures from the disclosed embodiments will occur to those having skill in the art. The subject matter that is intended to be within the scope of this disclosure is set forth in the following claims.

### INDUSTRIAL APPLICABILITY

The present disclosure finds applicability in the power tool and industrial tool industries.

1.-69. (canceled)

70. An engine comprising:
a crankcase;
a crankshaft mounted within the crankcase;
a fluid level window, including at least one fluid level indicator, mounted on the crankcase.

71. The engine as recited in claim 70, wherein the crankcase includes a crankcase cover configured to cover at least one opening in the crankcase and the fluid level window being mounted on the crankcase cover.

72. The engine as recited in claim 71, wherein the crankshaft is supported on only one end.

73. The engine as recited in claim 71, wherein the fluid level window is at least translucent.

74. The engine as recited in claim 70, wherein an outer most portion of the fluid level window protrudes from the crankcase cover surrounding the fluid level window.

75. The engine as recited in claim 70, wherein the fluid level window has a height and a width, and the width is at least four times the height.

76. The engine as recited in claim 70, wherein the at least one fluid level indicator comprises two fluid level indicators.

77. The engine as recited in claim 76, wherein the two fluid level indicators are spaced apart by a distance that is greater than one fourth of a height of the fluid level window.

78. The engine as recited in claim 70, wherein the crankcase has a length that is parallel to the crankshaft and a width that is perpendicular to the crankshaft, the crankcase cover having a width that is also perpendicular to the crankshaft and the fluid level window being formed to span more than sixty percent of the width of the crankcase cover.

79. A crankcase cover for sealing an opening in a crankcase, the crankcase cover comprising:
a body portion configured to be removeably coupled to the crankcase;
a fluid level window coupled to the body portion.

80. The crankcase cover as recited in claim 79, wherein the fluid level window has a proximal end and a distal end, the proximal end being coupled to the body portion and the distal end extending beyond a surrounding body portion.

81. The crankcase cover as recited in claim 79, wherein the distal end includes fluid level indicators signifying at least two different oil levels in the crankcase.

82. The crankcase cover as recited in claim 79, wherein the fluid level window (210) further comprises an endcap and four sides, wherein the endcap is located at the distal end of the fluid level window and four sides extend perpendicular to the endcap towards the proximal end of the fluid level window.

83. The crankcase cover as recited in claim 82, wherein the body potion defining a through hole such that the four sides of the fluid level window form a perimeter within the through hole.

84. The crankcase cover as recited in claim 82, where the proximal ends of the sides are configured to matingly engage with an opening formed in the body portion.

85. The crankcase cover as recited in claim 82, wherein sides comprise a top, bottom, left and right side, and the proximal ends of the left and right sides are sloped to match the slope of the body portion.

86. The crankcase cover as recited in claim 85, wherein the top side is shorter than the bottom side.

87. The crankcase cover as recited in claim 85, wherein the top side has a width that is narrower than a width of the bottom side.

88. The crankcase cover as recited in claim 85, wherein the bottom side is curvilinear.

89. The crankcase cover as recited in claim 88, wherein the curvilinear shape of the bottom side is such that it has a radius of curvature that substantially matches the radius of curvature of a bottom side of the crankcase.

90. The crankcase cover as recited in claim 85, wherein the left and right sides are curvilinear.

91. The crankcase cover as recited in claim 79, wherein the body portion has an exterior face and the exterior face has at least two slopes such that the two slopes are in opposite directions.

92. The crankcase cover as recited in claim 91, wherein the at least two sloped portions of the exterior face include an upper portion and a lower portion such that at the intersection of the lower portion and the upper portion the exterior face is the furthest away from the crankcase.

93. The crankcase cover as recited in claim 92, wherein the upper portion defining a plug receiving hole.

94. The crankcase cover as recited in claim 93, wherein the lower portion has an opening formed therein for receiving the fluid level window.

95. The crankcase cover as recited in claim 79, wherein the at least one fluid level window comprises two fluid level indicators.

96. The engine as recited in claim 95, wherein the two fluid level indicators are spaced apart by a distance that is greater than one fourth of a height of the fluid level window.
